(19) United States
(12) Patent Application Publication
(10) Pub. No.: US 2015/0251351 A1
(43) Pub. Date: Sep. 10, 2015

(54) REMOVE AND REFILL METHOD AND APPARATUS FOR LAMINATED OBJECT MANUFACTURING

(71) Applicant: Michael Feygin, Rancho Palos Verdes, CA (US)

(72) Inventor: Michael Feygin, Rancho Palos Verdes, CA (US)

(21) Appl. No.: 14/203,269

(22) Filed: Mar. 10, 2014

(51) Int. Cl. B29C 67/00; B29C 65/00

(52) U.S. Cl. CPC B29C 67/0051; B29C 65/00; B29L 2009/00

(57) ABSTRACT

An apparatus and method of manufacture for an integral three-dimensional object of unlimited complexity formed from individually contoured laminations (layers) produced from thin sheet materials that are stabilized on a removable carrier and formed both along and across the sheet material prior to stacking the contoured laminations in precise registration to one another. The waste material surrounding the laminations and the carrier is separated from the desired object. An optional method includes refilling the space surrounding the layers with another material and leveling the upper surface of the laminations. The process of forming the contoured laminations, separating the waste material, bonding, and stacking is continued until the construction of the desired three-dimensional object is complete.

### RELATED APPLICATIONS

This application claims the benefit of the priority date of U.S. provisional patent application No. 61/823,843, filed on May 15, 2013, titled “REMOVE AND REFILL METHOD AND APPARATUS FOR LAMINATED OBJECT MANUFACTURING”, the contents of which are hereby incorporated herein by reference.

### BACKGROUND OF THE INVENTION

The present invention relates to the field of additive manufacturing technology for three-dimensional (“3d”) apparatus and processes, commonly known as “3D-printing.” The present invention is more particularly directed to rapid prototyping, in particular Laminated Object Manufacturing (“LOM”).

Since their conception in the late 1980s 3D-printing or additive manufacturing technology offered manufacturers and consumers a powerful set of tools for making a variety of products rapidly, cost-effectively and with little waste. Manufacturers and government agencies believe that additive manufacturing technologies—including 3D-printing represent the future of manufacturing. While 3D-printing products are generally used by inventors, colleges and private individuals to create low quality plastic models, Additive manufacturing systems aim at producing previously impossible designs out of plastics, metals, composites and other advanced materials.

The dream that existed in the early phase of developing additive manufacturing technologies was that by the 21st century consumers and manufacturers would be able to make virtually any functional objects out of a variety of materials by printing them on their 3D-printing devices in a matter of minutes or hours. Even though these technologies have made a substantial progress since their inception, this vision has not yet been realized. Additive processes and materials are not nearly mature enough to sustain an entire manufacturing industry, which requires building assemblies and complex products with industrial grade materials. Layer-by-layer printing of items is simply not possible today at the speed and scale required to replace casting, molding, machining, assembly, and other traditional manufacturing methods.

The factors that limit the realization of the ultimate objectives of additive manufacturing include the following drawbacks: low speed of production (most of the processes form layers of their parts by covering every point of them with a moving deposition-nozzle or a scanning laser-beam); another speed-limiting factor is the requirement to form each layer of an object in sequence on the top of the previously formed layer. While the goal of 3D-printing is to eventually create parts comparable to injection molded or machined objects, the properties of object produced by 3D-printing are inferior to the industrial grade materials (most of the processes use either artificially developed materials, such as ultraviolet (UV) curable polymers, or create parts with porous structure or uneven strength along and across laminations, while they deposit or laser-sinter plastics or metals); need for the manually removable support-structures, which negatively affects ease-of-use for many technologies; and difficulty in directly creating assemblies, especially those composed of multiple materials.

LOM process invented by Michael Feygin in the late 1980s and commercialized by Helisys (the company that he founded) is unique among additive manufacturing or 3D-printing processes in its use of sheet materials as the basis for the part that it manufactures. The main competitive advantage of the sheet-based LOM process is in its ability to make parts out of pre-existing off-the-shelf sheet materials. Current additive manufacturing processes must form their materials point-by-point during the printing of their parts. On the other hand, LOM creates 3D pars by forming individual layers out of pre-existing sheet materials by cutting or etching them, attaching each newly formed layer to other layers in a precise registration, and removing the waste material surrounding them. LOM is the only process that is not simply additive, but is additive-subtractive. Since it only needs to outline or cut the boundary of material, which belongs to a given layer, it is much faster than other 3D-printing techniques, especially for larger parts. It also results in objects with potentially better properties. The main disadvantage of LOM process is that is does not simply add a material in a needed quantity to the object and, thus, generates waste in the form of material surrounding laminations

LOM process is based on two main principles. In his U.S. Pat. Nos. 4,752,352; 4,637,975; 4,354,414; 5,730,817 and 5,876,550 Feygin calls “cut-on-the-stack” and “cut-off-the-stack”. The “cut-on-the-stack” technique is based on, first, bonding a sheet to other laminations and then cutting it around the periphery of a given layer. This is the process, which has been commercialized by Helisys, Inc., the company that Feygin founded in the late 1980s. A fast, accurate, and reliable rapid prototyping system (3D laser printer) based on real time motion control, complex actuation systems, lasers, opto-mechnical assembly, optics, alignment, sheet material handling, computer aided design (CAD) and sophisticated software interface. The advantage of this method is that it results in a very simple 3D printer, naturally occurring support structure for the manufactured part, and that it assures precise registration of layers to one another. The disadvantage is that it is difficult to remove the support material surrounding laminated object, since it has a tendency to become bonded to the rest of the laminated stack unless special conditions are created for its removal.

The “cut-off-the-stack” is based on, first, cutting or forming a 3D part's layer out of a fabrication sheet material, and then bonding it to other laminations. The contours containing waste material surrounding these laminations are removed either prior to, or during the addition of a new layer to the stack. In his U.S. Pat. No. 5,015,312, Norman Kinzie explained a technique that involves using a backing tape that lightly adheres to the production material. This carrier stabilizes the material of the sheet prior to its cutting or forming in LOM process. Kinzie also explained various techniques for producing colored object by LOM technology, mainly out of materials that can transmit a color or absorb printing ink. On the other hand, Marshal Burns in his U.S. Pat. No. 6,575,218 explained several useful weeding techniques for removing waste-material-containing contours surrounding cut laminations prior to attaching them to the manufactured object.

One of the greatest challenges facing most of the additive manufacturing technologies is in their handling unsupported or overhanging (cantilever) layers or portions of the layers. In additive manufacturing processes, forming layers on the top of others requires the existence of a supporting layer underneath of the one being newly added. If this naturally occurring support structure does not exist in the process, it must be introduced by design into the manufacturing of each given object and then manually removed. This is a nuisance for the user and must be avoided. Some of the 3D-printing technologies, like stereolithography or selective laser sintering or 3D-printing binder into a power-bed have a natural support structure in the form of raw material surrounding the build object. The original “cut-on-the-stack” LOM process belongs to that category as well, since it keeps the material surrounding the cut layers around the laminated object. The surrounding material is cut by the “cut-on-the-stack” LOM process into cubes or columns for easy removal.

Another group of technologies that has existed on the market utilizes special process steps in order to introduce support layers into the manufactured part in a user-transparent fashion. These processes are generally more complex than the earlier-mentioned technologies and utilized two different materials in most of the layers that they form, one of the added materials being the manufacturing material of the desired object and the other being a sacrificial support-structure material. The resulting parts initially come out of the machine as a rectangular block containing a 3D part surrounded by the added support. At the end of the process the support structure is usually dissolved.

An early example of these processes includes a machine of an Israeli company Cubital, which pioneered Solid Ground Curing (U.S. Pat. No. 5,263,130), a multistep process that manufactured 3D parts out of UV-curable layers solidified through a xerographically produced mask surrounded by a support structure made out of water-soluble UV-curable polymer. Another Israeli company (Object, Inc.) which has been acquired by Stratasys, Inc. of Eden Prairie, Minn. has been manufacturing machines relying on dot matrix printing technology in order to sequentially print layers composed of a UV-curable material and surrounded with a printed support structure made out of a water-soluble UV-curable material. Stratasys, Inc. has also been manufacturing FDM machines, which utilize two nozzles, such that one nozzle extrudes melted plastic of the desired object, while the other nozzle dispenses water-soluble support structure. This FDM machine does not necessarily create fully supported parts, since the dissolvable support structure still needs to be purposely designed.

Accordingly, there is a need for, and what was heretofore unavailable, an improved LOM apparatus and process that increases the efficiency and reduces the cost of manufacturing integral and complex three-dimensional objects. The present invention satisfies these and other needs.

### SUMMARY OF THE INVENTION

Briefly, and in general terms, the present invention generally relates to manufacturing apparatus, method of manufacture, and products manufactured thereby and more particularly to an integral three-dimensional (3D) object of unlimited complexity formed from individually contoured laminations of the same or gradually varying shape. Successive laminations of 3D printed objects are produced in accordance with the present invention from thin sheet materials, including water or solvent soluble plastic sheets, thermoplastic sheets, metal foils, and ceramic and composite sheets. The laminations are stabilized on a removable carrier or a conveyor, or a vacuum/magnetic/electrostatic table and formed through mechanical or laser cutting, or chemical or water etching, or sand carving. The laminations are formed in an array of locations distributed both along the sheet material and across the sheet material prior to stacking the laminations in precise registration to one another. Waste material surrounding the laminations and the carrier or conveyor are automatically separated from the desired object.

An optional method of the present invention further includes applying refilling material to occupy the space surrounding the contoured laminations with another material. The contoured laminations are moved by the carrier, and after the removal of the waste material surrounding the laminations; the upper surface of the laminations are leveled. After leveling, the contoured laminations are stacked in precise registration to one another. The carrier material is then peeled away from the laminations, and the forming, bonding, and peeling steps are continued until the lamination of a desired three-dimensional object is complete. Alternatively, since the contoured laminations maintain their integrity due to the refill material, the laminations are first peeled away from the carrier, and then the laminations are assembled on the stacking platform. Thereafter, the process includes dissolving or otherwise removing either the refill material portion of the laminated part or the portion of the laminated part containing the original fabrication sheet material.

The present invention is directed to a laminated object manufacturing (“LOM”) apparatus for forming integral objects from sheet laminations. The apparatus includes a layer-forming station that forms individual contoured laminations (layers) of a three-dimensional (“3D”) in an array distributed along and across a film attached to a carrier ribbon or carried by a conveyor. The apparatus also has a stacking station where the contoured laminations are assembled in precise registration to each other contoured lamination.

The LOM apparatus of the present invention may further include a mechanism for moving a length of film stabilized on a vacuum or electrostatic conveyor or a removable carrier. In addition, the apparatus has one or more devices for forming an array of contoured laminations of the 3D object from the film, such that the contoured laminations are distributed both along the film and across the film. The apparatus may include a sub-apparatus the removes the individual contoured laminations from the carrier or the conveyor. The machine of the present invention may be configured to stack and bond the contoured laminations in precise registration to each other contoured lamination, and adapted to insure that the stacked laminations are in precise alignment with one another.

The present invention includes a method of forming an integral three-dimensional object from sheet laminations from a length of film material. The process defines the shape of consecutive contoured laminations (layers) of the three dimensional object by dividing the film into a first region that forms a contoured lamination and into a second region that surrounds and connects each contoured lamination. Consecutive contoured laminations of the 3D object are distributed both along the film material and across the film material. The physical connection is maintained between separate portions of each contoured lamination prior to the attachment of each contoured lamination to the other contoured laminations after at least some of the waste portions the film surrounding the laminations that do not belong to the layers of the 3D object have been removed. The contoured laminations are aligned in precise registration to each other contoured lamination while the contoured laminations are being stacked and bonded to each other contoured lamination. The media that connects each contoured lamination is removed after one or several of the contoured laminations have been attached to the stack.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a side perspective view of a laminated object manufacturing apparatus of the present invention.

FIG. 2 is a side plan view of a laminated object manufacturing apparatus having concurrent waste removal mechanisms in accordance with the present invention.

FIG. 3 is an upper partial end perspective view of a laminated object manufacturing carriage having layer-forming tools in accordance with the present invention.

FIG. 4 is a lower partial end perspective view of a laminated object manufacturing apparatus depicting waste separation in accordance with the present invention.

FIG. 5 is a partial side perspective view of a laminated object manufacturing apparatus having concurrent waste removal mechanisms in accordance with the present invention.

FIG. 6 is a partial front perspective view of a laminated object manufacturing apparatus depicting concurrent waste removal in accordance with the present invention.

FIG. 7 is a top perspective view of a cut layer having waste contours in accordance with the present invention.

FIG. 8 is a partial top perspective view of a laminated object manufacturing apparatus depicting waste removal by selective adhesive deposition in accordance with the present invention.

FIG. 9 is a schematic representation of a waste removal process using a magnetized sheet and selective adhesive deposition in accordance with the present invention.

FIG. 10 is a partial top perspective view of a laminated object manufacturing apparatus depicting waste removal by adhesive activation assisted by a peel-off ribbon in accordance with the present invention.

FIG. 11 is a schematic representation of a waste removal process using selective bonding in accordance with the present invention.

FIG. 12 is a schematic representation depicting waste material removed from a backing ribbon in accordance with the present invention.

FIG. 13 is a partial top perspective view of a laminated object manufacturing apparatus depicting waste removal using an etching process in accordance with the present invention.

FIG. 14 is a partial top perspective view of a laminated object manufacturing apparatus depicting refilling sacrificial material within individual cut layers in accordance with the present invention.

FIG. 15 is a perspective view of a refilling nozzle in accordance with the present invention.

FIG. 16 is a schematic representation depicting a laminated object manufacturing refill process using a metal foil in accordance with the present invention.

FIG. 17 is a schematic representation depicting laminated object manufacturing process using a sand blasting mask in accordance with the present invention.

FIG. 18 is a schematic representation depicting an alternative embodiment of the laminated object manufacturing process of FIG. 17 further using a block of material.

FIG. 19 is schematic representation depicting an alternative embodiment of a laminated object manufacturing process in accordance with the present invention.

FIG. 20 is perspective view of an alternative embodiment of a laminated object manufacturing apparatus in accordance with the present invention.

FIG. 21 is schematic representation depicting a multilayered refill process in accordance with the present invention.

FIG. 22 is schematic representation depicting a process for forming a multi-cavity sacrificial mold for multi-material parts and assemblies in accordance with the present invention.

FIG. 23 is perspective view of an alternative embodiment of a laminated object manufacturing apparatus depicting parallel processing with concurrent waste removal in accordance with the present invention.

FIG. 24 is schematic representation depicting a bio-printer utilizing a sacrificial film in accordance with an alternative embodiment of the present invention.

FIG. 25 is schematic representation depicting a plasma spray process in accordance with an alternative embodiment of the present invention.

FIG. 26 is a side perspective view of an alternative embodiment of a laminated object manufacturing apparatus of the present invention.

FIG. 27 is schematic representation depicting an alternative material path of the laminated object manufacturing apparatus of the present invention that combines a layer-forming module with a laminating module.

### DETAILED DESCRIPTION OF THE INVENTION

As shown in the drawings for purposes of illustration, the present invention generally relates to manufacturing apparatus and methods of manufacturing products. The manufacturing apparatus and methods of the present invention are more particularly directed to an integral three-dimensional (“3D”) object formed from individually contoured laminations of the same or gradually varying shape. The present invention is further directed to the manufacture of products using a rapid prototyping system that is currently known as “3D-printing.”

### DEFINITIONS

“UV developed sheet material”: A film or foil whose chemical or physical properties are selectively altered by its selective exposure to UV or another light source. Some materials (for example, water-soluble mask available from Ikonics, Inc. of Duluth, Minn.) become water or chemical insoluble once exposed to UV light. Some sheets (for example, Ikonics Imaging's RapidMask dry processing, self adhesive, photoresist films become fragile when exposed to UV light) become fragile when exposed to UV light). Some materials (like metal foils) become non soluble in chemicals in the areas covered with a UV cured photo-resist layer or a mask.

“Selective removal”: Washing away with water or a solvent, or sand-blasting away preselected portions of “UV developed sheet material”. Selective removal can also be accomplished by cutting or ablation by a laser or another energy beam, or knife based cutting.

“Forming means”: Technologies used for defining the shape of consecutive layers of a three dimensional object by dividing the film into regions that constitute the layers of the object and the surrounding regions intended for removal.

“Removing means”” Technologies used for removing waste portions the film that do not belong to the layers of the 3D object; In the case of forming layers by the laser based ablation, the “removing means” are the same as “forming means”. On the other hand in the cases involving “UV developed sheet material” the layer forming means are comprised of the pattern of UV light, while the removing means are comprised of chemical etching or sand blasting media application.

“Refill”: Technologies used for refilling the spaces vacated by the “selective removal”. The refill can be performed with a plastic, metal, ceramic or another refill material. It can be accomplished by delivery through a nozzle, or by electro-depositing a metal, or by spraying a metal, or a ceramic, or composite, or plastic material;

“Connecting means”: Methods used for maintaining physical connection between separate regions comprising the formed layers prior to their attachment to each other, so that the unconnected portions of the layers remain in registration to one another after the material surrounding them has been partially or fully removed. They may include using a carrier sheet lightly bonded to the fabrication film, or refilling the spaces vacated by the “selective removal” with another material, or keeping some portions of the original fabrication sheet unremoved after the energy beam or knife-based layer-forming step. In the case of the laser based ablation those portions may come in the form of connecting tabs, or a thin portion of the original sheet material remaining at the bottom of a partially ablated layer. Connecting means are removed after bonding a layer to the stack of other layers.

“Stacking means” are comprised of mechanisms used for stacking the formed layers;

“Alignment means” are comprised of sensors or mechanical alignment techniques used for precise registration layers being stacked.

“Bonding means: Technologies used for bonding the stacked layers to each other.

They can include application of adhesives between the consecutive layers. Part's layers can also be bonded to each other by the diffusion bonding, which uses heat and pressure without assistance of an adhesive.

One embodiment of the manufacturing apparatus of the present invention includes two stations: a first “layer-forming station” where individual contoured laminations of a three-dimensional object are formed in an array distributed over the surface of a carrier sheet (ribbon); and a second “stacking station” where the individual contoured laminations are assembled in precise registration to each other contoured lamination. The machine is configured with an unwind roll for supplying the carrier sheet that is collected on a rewind roll. The carrier sheet is lightly bonded to a sheet of fabrication (raw) material that form the individually contoured laminations. Several envisioned machines rely on the further-described manufacturing methods of the present invention. The apparatus of the present invention automatically and precisely define the shape of laminations of the manufactured object by cutting or forming them from the fabrication material. In accordance with the present invention, the apparatus also removes waste material contours surrounding the individually contoured laminations that form the three-dimensional object as an end product of the devices and processes of the present invention.

In another aspect of the present invention, individually contoured laminations of product material are formed both along the carrier sheet and across the carrier sheet prior to stacking the product laminations. Optionally, the apparatus and method of the present invention includes applying refilling material within spaces surrounding the individually contoured laminations while the laminations are disposed on the carrier sheet and after the removal of the waste material. A further aspect of the present invention includes leveling the upper surface of each contoured lamination after refilling material has been applied to the lamination. Alternatively, the stacking station may be a separate machine located some distance away from the laminating station to form an alternative embodiment of the apparatus of the present invention.

Another embodiment of the 3D printing process of the present invention is directed to manufacturing 3D metal or ceramic objects through plasma or other spray refill processes. For example, the plasma spray method may include attaching a sheet of sacrificial material to a carrier sheet and ablating a portion of the sacrificial material. The ablation can be accomplished by a scanning laser beam delivered by an automatic laser engraver manufactured by such companies as Universal Laser Systems, Inc. or Epilogue, Inc. The vacated spaces in the sacrificial material are refilled with a lamination material using a spray mechanism known to one of ordinary skill in the art. The sprayed substance refills the spaces in the contoured lamination vacated by the ablation. A grinding or other device may be used to level the surface after the refill step. The ablating, refilling and grinding steps may be repeated for additional refill materials. Instead of plasma spray the earlier described manufacturing method may rely on refilling the spaces vacated by the ablation with a molten or electrodeposited metal, a molten wax, or a plastic, a biological cell based substance, or a powder-based slurry. Later on, the layers of the 3D object are separated from the carrier and from each other. Then, they are stacked and bonded to each other. The usage of a carrier sheet may be avoided if prior to the refill and grinding on the top and on the bottom, the sacrificial material is ablated only partially to a depth leaving a thin membrane of the sacrificial material at the bottom.

The manufacturing apparatus may be configured so that the laminating station is configured for parallel processing in order to form the individually contoured laminations of the product material at a first portion of the machine while a second portion of the machine peels away carrier material and excess product material bonded to the carrier sheet. The manufacturing process continuously performs each of the contoured lamination forming, excess material bonding, and peeling steps until each of the individually contoured laminations needed to produce a desired three-dimensional object is complete. Furthermore, since the laminations maintain their integrity when refill material is added to each individually contoured lamination, the product laminations may be first removed from the carrier sheet (peeled away) then assembled on a stacking platform and bonded to form a three-dimensional object. Thereafter, either the refill material portion of the laminated object, or the bonded laminations portion is dissolved or otherwise removed in order to provide the desired end product.

An important aspect of the manufacturing process is computer software that operates the apparatus. Suitable user interface software for use with the several embodiments of the present invention includes, but is not limited to, SolidWorks (Dassault Systèmes SolidWorks Corp. of Waltham, Mass.) and AutoCAD (Autodesk, Inc., San Rafael, Calif.). The manufacturing process also requires machine control software. The user interface software and the machine control software and processes are described in U.S. Pat. Nos. 4,752,352; 4,637,975; 4,354,414; 5,730,817 and 5,876,550, which are incorporated herein by reference.

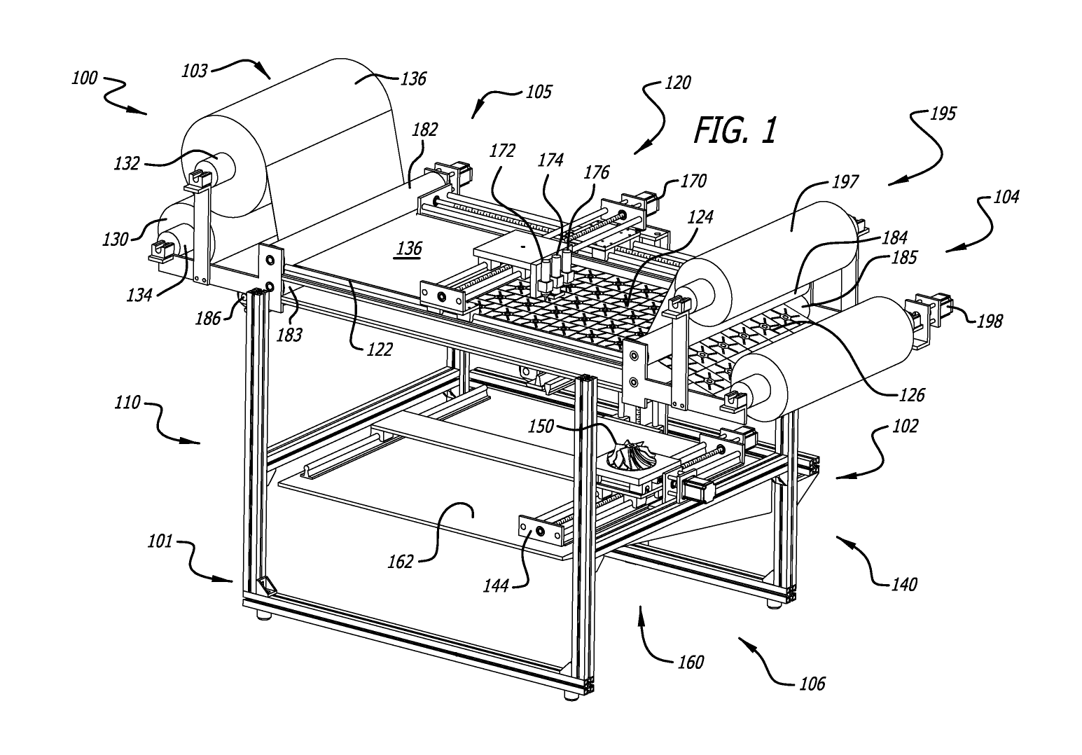

Turning now to the drawings, in which like reference numerals represent like or corresponding aspects of the drawings, and with particular reference to FIGS. 1-4, one embodiment of the laminated object manufacturing apparatus 100 of the present invention has a front portion 101, a back portion 102, a first end portion 103, a second end portion 104, a top portion 105 and a bottom portion 106. The laminated object manufacturing apparatus is configured with two stations: (1) a lamination forming station 120 where individual contoured laminations (product layers) of a three-dimensional object are formed in an array distributed over the surface of a carrier ribbon or conveyor; and (2) a stacking station 140 where the individual contoured laminations 124 of the three-dimensional object 150 are assembled in precise registration to one another.

The first end portion 103 of the laminated object manufacturing apparatus 100 is configured with a continuous carrier sheet (ribbon) 130 fed from an unwind roll (material supply reel) 132 and collected on a rewind roll (material take-up reel) 134. The carrier sheet is lightly bonded (removable) to a sheet of fabrication material 136 used as a raw product for manufacturing three-dimensional objects of unlimited complexity from contoured laminations. Several envisioned machines in accordance with the present invention rely on the further-described manufacturing methods, some of which not only automatically and precisely define the shape of layers of the manufactured object by cutting the contoured laminations 124 in the fabrication material, but also automatically remove waste material contours 126 surrounding the contoured laminations.

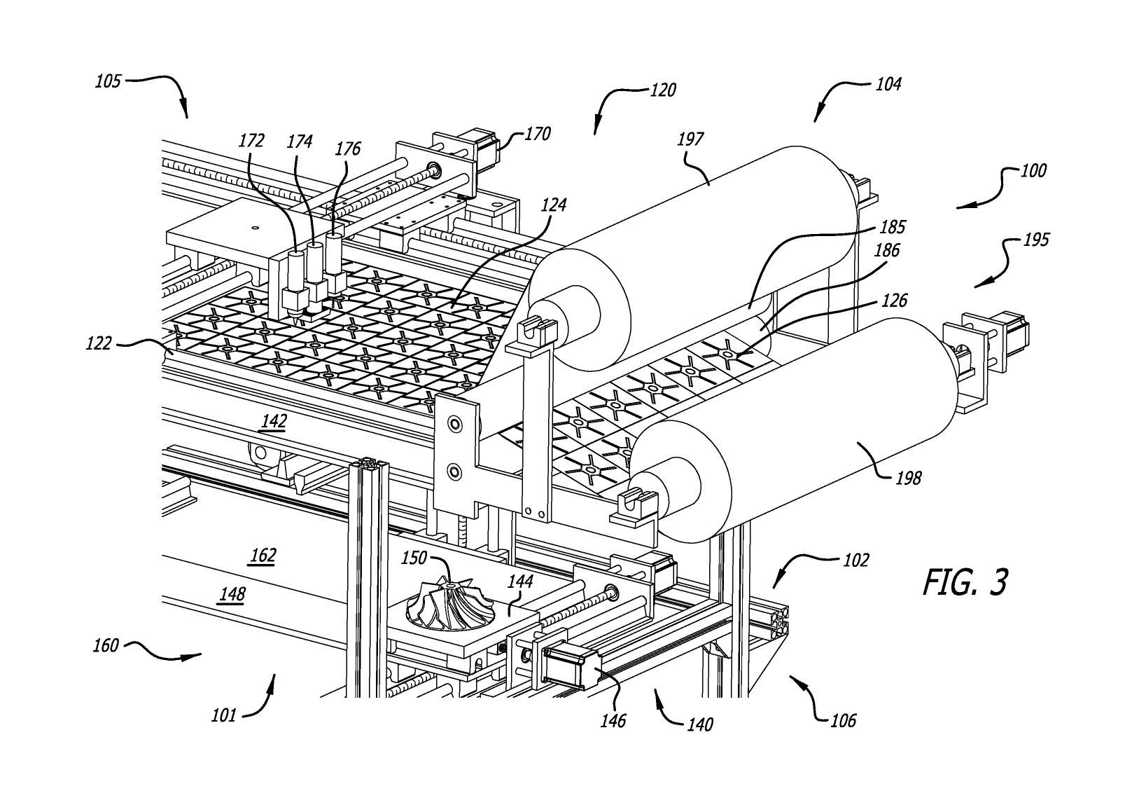

Referring to FIGS. 1 and 3, the lamination forming station 120 is located on the top portion 105 of the laminated object manufacturing apparatus 100. The flat top surface 122 of the machine is covered with the fabrication material 134 fed from the material supply reel 132. The carrier sheet 130 may be secured to the flat top surface using a vacuum from a suction apparatus (not shown) configured within the forming station. The carrier sheet is advanced by a first set of motorized drive rollers 182, 183 on the top portion 105 and first end 103 of the apparatus. At the second end 104 of the apparatus, the carrier sheet passes through second a set of motorized rollers 184, 185. The carrier sheet then turns back towards the carrier sheet rewind (material take-up) roll 134 located at the first end of the apparatus and underneath the material supply roll 132. The carrier sheet is stabilized at the first end of the apparatus between a bottom roller 186 and the first drive lower motor 183 prior to being wound on the carrier sheet rewind roll.

The material forming the carrier sheet 130 may be a thin sheet plastic, configured to be detachable from the product material 136. Accordingly, the carrier sheet is lightly and removably attached to the fabrication sheet. The carrier sheet material may be paper-based (for example, silicone coated), similar to the backing used in vinyl sign-cutters or self-sticking labels.

As described herein, when a laser beam is used as a cutting tool, then the carrier material is preferably a thin foil or a foil-coated paper in order to prevent the laser beam from cutting through the carrier sheet. The adhesive (or a vacuum/magnetic/electrostatic device) that stabilizes the sheet of product material on the carrier sheet should be configured so as to not contaminate the surface of the product that would prevent adhesion of each individual product layer to each adjacent layer.

The fabrication material 134 may be formed from commonly used plastic films or sheets, such as rigid polyvinylchloride (PVC), Styrene, polycarbonate, polypropylene, and ABS. As desired, the fabrication material may formed from waxes, metal foils (for example, aluminum, steel, stainless steel, copper and gold), composites (for example, containing para-aramid synthetic fibers, PTFE, graphite and glass) or any other suitable material known to those of one of ordinary skill in the art for forming the final product object 150. A preferred thickness of the fabrication material is from 0.002 inches (0.0508 millimeters) and up to 0.020 inches (0.508 millimeters), but it can be either thicker or thinner, depending upon the product material strength and the design of the final product object.

The product sheet 134 can be plasma treated to enhance adhesion of the contoured laminations 124. Similarly, the product sheets can be coated with various adhesives, including light activated adhesives, to enhance bonding of the contoured laminations.

The top portion 105 of the laminated object manufacturing apparatus 100 includes a XY positioning device (carriage) 170 that carries and manipulates various tools 172, 174, 176 used in the layer-forming process. The XY positioning device is positioned above the ribbon of fabrication material 136. One tool attached to the XY positioning device is a cutting device 172 (for example, a knife or a laser) that is used for cutting the boundaries of each individual product layer (contoured laminations) 124. A color print head 174 may also be connected to the carriage. Another tool connected to the carriage may be an adhesive deposition device 176, which, by way of example, can be formed from a needle or a print head. The adhesive deposition device is used for computer-controlled selective deposition of an adhesive onto strategically selected regions of contoured laminations formed on the fabrication ribbon by the cutting tool. Suitable adhesives include, but are not limited to, pressure sensitive, heat sensitive, and UV curable.

As shown in FIGS. 1-4, the stacking station 140 is located in the lower portion 106 of the laminated object manufacturing apparatus 100. The stacking station includes a laminating platen 142 positioned under the flat top surface 122 of the layer forming (laminating) station 120. By way of example, the laminating platen may be configured as a flat pressure plate having heating mechanism. The laminating platen can also be enhanced with a vacuum suction enabling machine (not shown) to stabilize the carrier ribbon during the laminating process. The laminating platen is used for pressing and heating each individually contoured lamination as the lamination are attached to the stack of laminations positioned on a laminating platform 144. The carrier sheet 132 having the individually contoured laminations 124 is moved under the surface of the laminating station and adjacent the laminating platen by a combination of rollers 184, 186 and 185 as the carrier sheet is routed from the second end portion 104 toward the take-up reel 134 at the first end portion 103 of the apparatus.

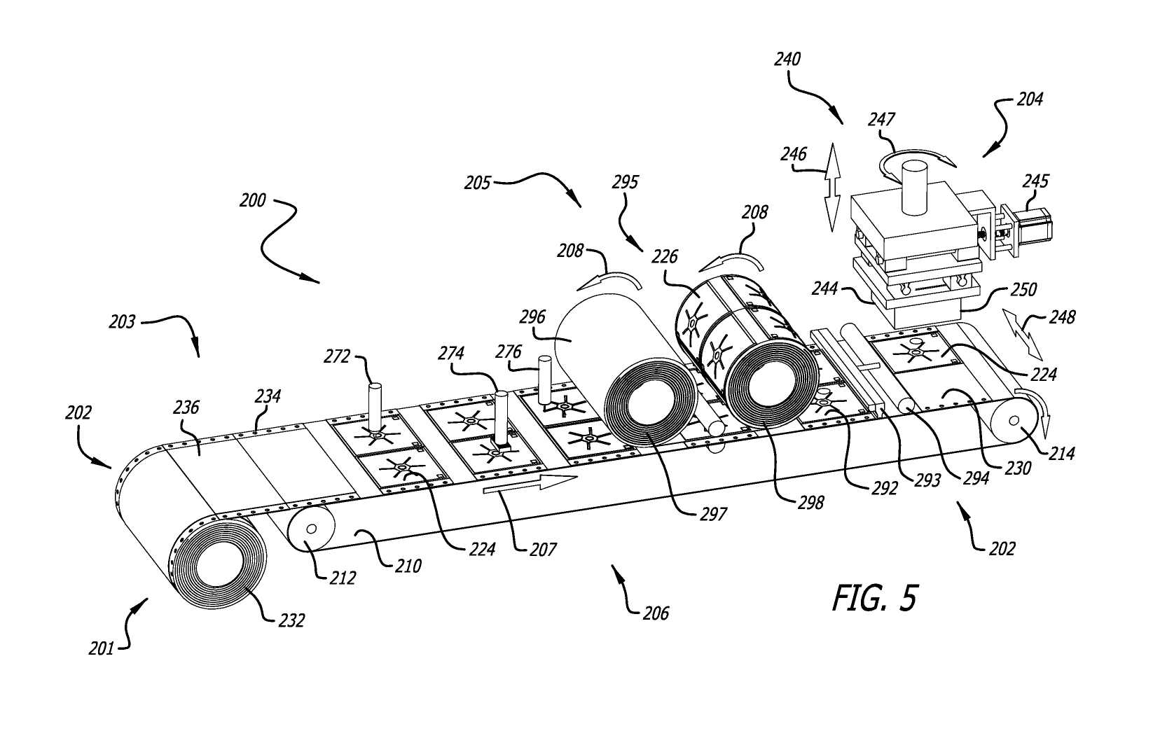

The laminating platform 144 may be computer controlled with at least three degrees of freedom. The laminating platform may move horizontally 248 (FIG. 5) across the carrier sheet 134, vertically 246 (FIG. 5) between the bottom portion 106 and the top portion 105 of the apparatus, and may rotate about its axis 247 (FIG. 5). The computer controller may be resident in the LOM apparatus or externally connected. The programming data for the object may be resident in a computer file, contained on a removable memory device (for example, a flash drive) or wirelessly downloaded to the positioning control device.

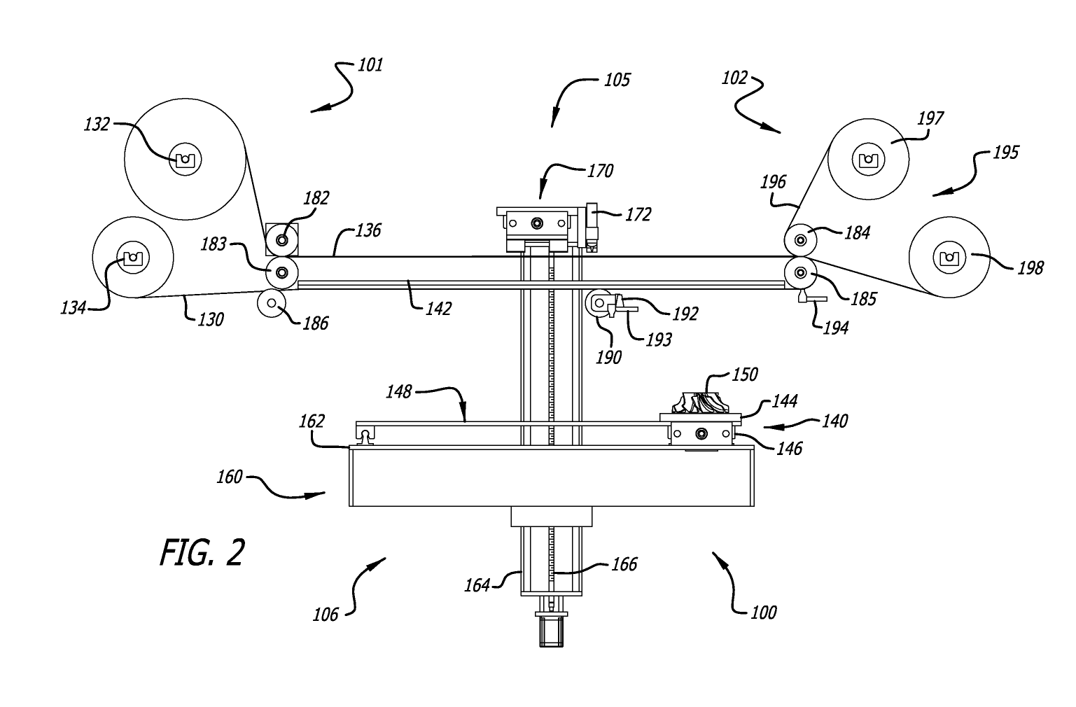

As shown in FIG. 2, the vertical stage 160 is mounted on the back portion 102 of the laminated object manufacturing apparatus 100. The vertical stage is a sub apparatus (machine) used for moving a vertical stage platform 162 from the bottom portion 106 towards the top portion 105 of the apparatus. The laminating platform 144 of the stacking station 140 is secured to the vertical stage platform. The platform is slidably secured to a housing 164 that includes a drive mechanism 166. Accordingly, the vertical stage platform is configured to move the laminating stage ‘upward’ so as to press the previously stacked and bonded contoured layers 150 on the laminating platform against the next individually contoured layer 124 and onto the stack. Accordingly, the vertical stage provides an “up-and-down” motion of the entire stacking station. During the laminating process the vertical stage platform 162 carrying the laminating platform 144 moves towards and away from the laminating platen 142 (heater plate).

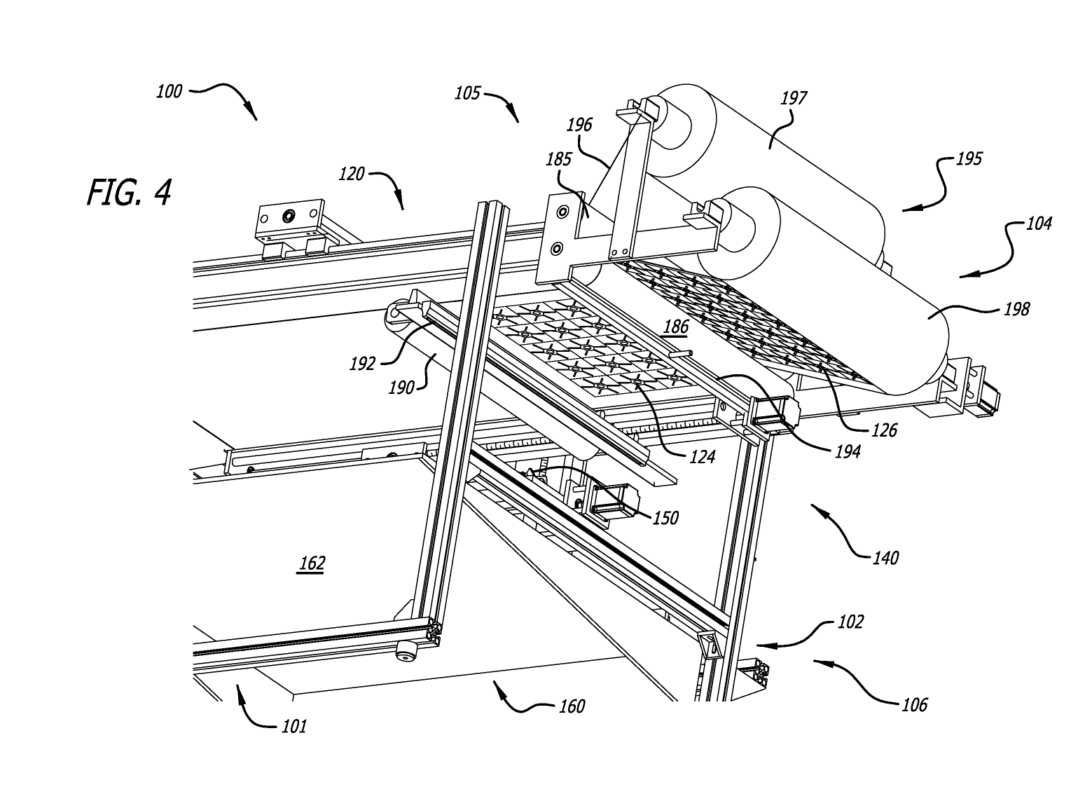

The stacking station 140 further includes a horizontal sub-assembly 146 having one or more computer-controlled mechanisms capable of moving the laminating platform 142 across the width—from front 101 to back 102 of the apparatus 100. The laminating platform may be stabilized on the vertical stage 160 by slidably attaching a bar/rod/flange 148 to the vertical stage platform 162. The horizontal sub-assembly provides movement of the laminating platform with respect to the individually contoured layers 124 distributed across the width of the carrier sheet 136 as each individually contoured lamination is positioned above the stacking station. In accordance with an aspect of the present invention, a plurality of individually contoured laminations (FIG. 4) may be formed across one horizontal position of the carrier sheet and then stacked in sequence to add increased efficiency and speed to the laminated object manufacturing apparatus.

Referring again to FIG. 2, a peel off (strip off) roller 190 reciprocally movable on linear guides positioned horizontally (from the second end portion 104 towards the first end portion 103) along a surface near the bottom of the laminating platen 142. The roller moves under the platen after the machine attaches an individually contoured lamination to the stack of previously attached and bonded layers residing on the laminating platform 144. The movement of the peel off roller exerts a force on the carrier sheet 130 so as to separate the carrier sheet from the newly adhered layer 126, which remains on the object stack 150 being formed on the laminating platform.

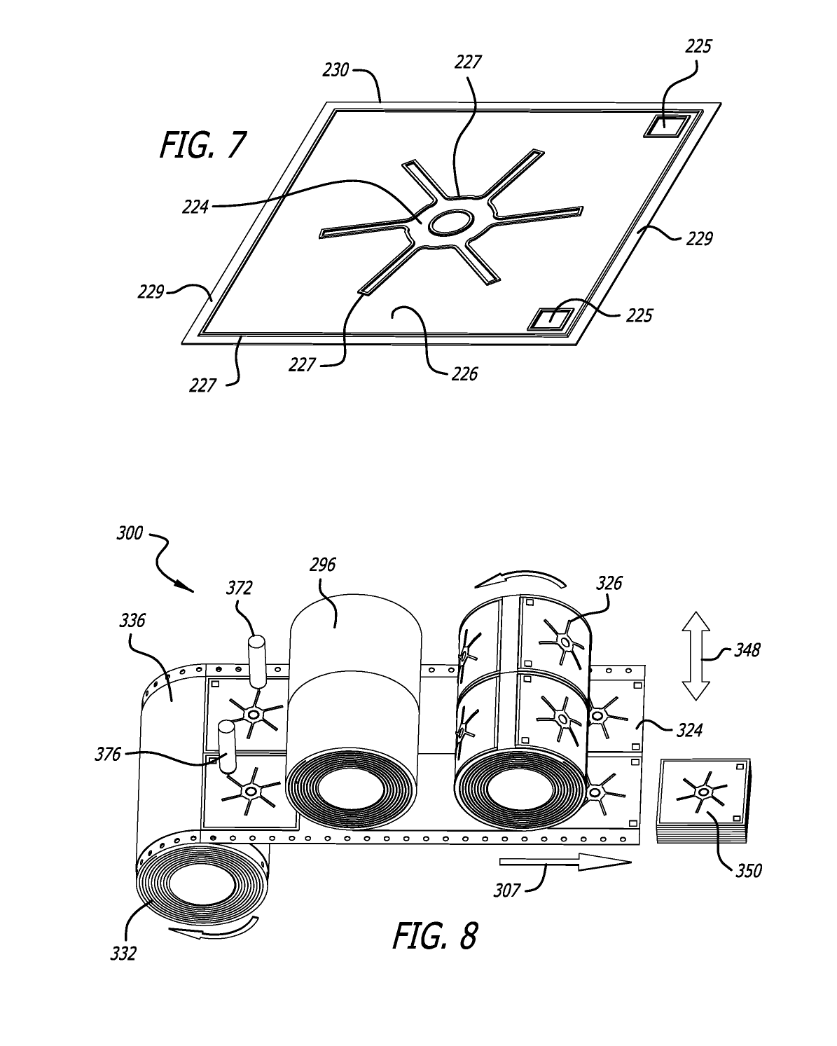

The peeler roller assembly 190 may be configured with a scanner 192. The scanner reads the locations of registration markers 125 (FIG. 7) associated with individually contoured laminations 124 prior to the positioning of each lamination onto the object stack 150. The registration markers are formed in the waste product material 126 on the carrier sheet 130. During the stacking step, the scanner provides registration information to a computer (not shown), which adjusts the position of the object stack located on the laminating platform 142. The laminating platform is positioned by the horizontal sub-assembly 146 and by the moving vertical stage platform 162, both of which are computer controlled in response the registration position provided by the scanner.

The laminated object manufacturing apparatus 100, 200 of the present invention is configured so that each individually contoured lamination 124, 224 produced at the laminating station 120 will always stay in registration with prior layers as each new lamination moves toward and onto the laminating platform 144. As shown in FIG. 5, for example, the fabricating material may be disposed on a perforated carrier ribbon 230 moving through sprockets 232. Alternatively, the carrier sheet may be stabilized on a conveyor while the carrier sheet and product material move within the machine by utilizing vacuum, magnetic and/or electrostatic devices. Similarly, barrel rollers may be used to stabilize the carrier ribbon in a relative fixed horizontal and vertical position as the product material and individually contoured laminations move from the first end portion 101, 201 to the second end portion 102, 202. To insure proper registration, however, an active registration assisted with computer-controlled stages may be required.

Referring again to FIG. 2, the laminated object manufacturing apparatus 100 is configured with a “weeding” (weeder) mechanism 195 having a peel-off (weeding) tape 196 carried from its feed (unwind) roll 197 to its take-up (rewind) roll 198. The weeding tape is pressed against the upper surface of the fabrication material 124 and carrier sheet 130 by the top and bottom drive rollers 184, 185 positioned at the of the second end 102 of the apparatus. Those drive rollers at the second end portion of the apparatus or the pinch rollers 182, 183, 186 that are located near the feed roll 132 for the fabrication material and carrier sheet at the first end portion 101 of the apparatus can be used for advancing the fabrication material and carrier sheet.

The peel off (weeding) tape 196 of the weeding mechanism is frictionally engaged with the fabrication sheet 136 of the apparatus 100. The weeding tape unwind roll 196 and rewind roll 197 are held under a light tension in the opposite directions by tension motors (not shown). The tension will advance the weeding tape automatically and concurrently with the movement of the fabrication sheet. The purpose of the weeding tape is to peel-off waste portions 126 of the fabrication material after the individually contoured laminations 124 have been cut by a knife or a laser 172. The waste portions are removed (peeled off—weeded) by advancing the weeding tape together with the fabrication sheet. When the weeding tape comes into contact with the adhesive-coated portions of the layers formed on the fabrication sheet residing on the carrier sheet 130, the weeding tape adheres to the adhesive-coated portions of the layers. Alternatively, the adhesive-coated portions of the layers are made (caused) to adhere to the weeding tape through adhesive activation cased by heat, light, pressure or any other suitable adhesive-activating device (see FIG. 23).

In accordance with an embodiment of the laminated object manufacturing apparatus 100 of the present invention, a fabricating cycle starts when the fabricating sheet 136 advances from the unwind roll 132. Then a knife, laser or other cutting device 172, which is carried by the final carriage of a XY positioning system 170 of the machine positioned above the fabricating sheet, cuts contours of a plurality of consecutive laminations of a three-dimensional object. The cuts are performed through the fabrication sheet without damaging the carrier sheet 130. As shown on the FIG. 3, the same (final) carriage may also contain and manipulate an adhesive deposition device 176. The purpose of this deposition subsystem is to precisely deposit adhesive within the waste-containing contours surrounding each individual cut lamination. The adhesive can be pressure-sensitive. The adhesive can also be a hot-melt material, wherein the weeding mechanism 195 may be configured (provided) with a heating device so that the contours of waste material will be bonded to the peel off tape 196 of the weeding mechanism. Alternatively, the adhesive may be formed from a light-activated substance.

As shown in FIG. 3, the XY positioning system 170 may include third tool, such as a print head 174 for printing color patterns corresponding to the color scheme of the desired three-dimensional object 150 under the construction. Depending on the transparency of the fabrication material (product) sheet 136, the color can be printed either before or after the cutting step (formation of the individually contoured laminations 124). If the fabrication material is non-transparent, then the color is printed after cutting the contoured laminations. In accordance with the present invention, the sequence of the lamination forming steps can be interchanged. If desired, the color-printing step or the adhesive-deposition step may be performed prior to the cutting of the laminations. For example, if a knife rather than a laser beam is used for the cutting, then pre-deposited adhesive may contaminate the knife assembly during the cutting step. This makes adhesive deposition after the cutting desirable.

Referring to FIG. 4, the carrier sheet 130 and the weeding (peel-off) tape 196 separate after the two sheets have been pressed together by the pinch rollers 185, 186. The weeding tape contains the contours of waste material 126 as the tape moves towards the weeding tape rewind roll 198. Simultaneously, the carrier sheet moves the contoured laminations (cross-sections of the manufactured part) 124 in the opposite direction (away from the weeding tape rewind roll) and towards the stacking station 140 and lamination platform 144.

A computer, which controls the motion of the vertical stage platform 162 and the stacking platform 144, receives information about the precise orientation of each contoured lamination 124 delivered to the stacking location by the carrier sheet 130 from the scanner 192 positioned on the reciprocating peel-off roller 190. The information provided by the scanner is used by the computer to make corrections to the position of the stacking platform as the platform moves towards each lamination in the process of pressing the stack 150 of contoured laminations against the lamination platform and bonding each layer of contoured laminations to the stack. Once a contoured lamination adheres to the stack, the platform goes down (moves towards the bottom portion 106 of the LOM apparatus) and makes a short move towards the weeding mechanism 195 in order to create slack in the carrier sheet. Next, the peel-off roller is moved parallel to the laminating platen 142 and becomes partially wrapped into the slacked carrier material while peeling the carrier material away from the newly bonded contoured lamination on the stack.

Aspects of the present invention include methods and processes directed to operation of a particular embodiment of an apparatus in accordance with the present invention. One such method includes forming individual layers (contoured laminations) of a three-dimensional object free of waste material on a carrier sheet. This method includes the following steps: (a) forming a plurality of thin consecutive contoured laminations of a three-dimensional object distributed in an array of locations both along and across a removable carrier sheet containing a lamination product material; (b) positioning a stacking platform having a mechanism for computer-controlled alignment of the platform with the contoured laminations formed in the lamination material on the carrier sheet; (c) contacting the laminating platform with each consecutive contoured lamination, such that each individually contoured lamination is added onto the platform in precise alignment to and bonded to other contoured laminations on the platform; (d) peeling away the carrier material from each consecutive contoured lamination, and (e) repeating the forming, positioning, bonding, and peeling steps until the construction (lamination) of a three dimensional object is complete.

As shown in FIG. 5, one embodiment of the laminated object manufacturing apparatus 200 of the present invention is configured to provide a “cut-before-bond” system that uses an adhesive-deposition method for removing contours of waste material 226. In this embodiment, a sheet of raw product material 236 is supplied on a carrier sheet 230 from a supply (unwind) roll 232 positioned at a first end 203 of the machine. The carrier sheet can be further stabilized on a vacuum conveyor 210 (or vacuum table) having rollers 212, 214 positioned at the first end and the second end 204 portions of the machine. A computer-controlled cutter 272 is positioned to move in an XY plane 288 (from front 201 to back 202 of the apparatus) at a first station following (moving toward the second end portion—arrow 207) the supply roll. The next station prints colors using a print head 274, and a station further towards the second portion includes a positioner that manipulates an adhesive deposition device 276.

A weeder (peel off, weeding) mechanism 295 follows after (toward the second end portion 204 of the apparatus 200) the layer forming (cutting) 272 and adhesive deposition 276 devices as has been described in reference to FIG. 5. The weeding mechanism removes the contours of waste 226 from the carrier sheet 230. A scanner 292 is positioned toward the second end portion after the carrier sheet and the remaining product material passes through the weeding mechanism. The scanner reads the exact locations of the formed contoured laminations 274 and passes under a coating nozzle or device 293 that that is configured to coat the contoured lamination with a solvent or an adhesive. Alternatively, the coating nozzle may be configured to provide a secondary material to fill spaces around product material in the contoured laminations and on the carrier sheet that are exposed by the weeder mechanism.

A stacking station 140 is positioned at the second end portion 204 of the machine 200 above (205) the carrier sheet 230 and the individually contoured layers 224. The stacking station may be configured to move on an XY plane (arrow 248) along each sequential contoured lamination layer. The stacking station may include a stage configured for rotary movement (arrow 247). A laminating platform 244 is located at the bottom (206) of the stacking station. The stacking station is configured to move in a vertical direction (arrow 246) to contact the platform against each sequential lamination layer so as to provide stacking of the individually contoured layers.

In an embodiment of the process of using the laminated object manufacturing of the present invention the plurality of the consecutive contoured laminations are formed to be waste-material-free. The process of providing contoured lamination containing no waste-material may include the entirety of individually contoured laminations comprising a three dimensional object or just several of the contoured laminations. The present invention contemplates several methods of forming a plurality of waste-material-free laminations on a carrier sheet as described herein. As used herein, the term “plurality” means “more than one.”

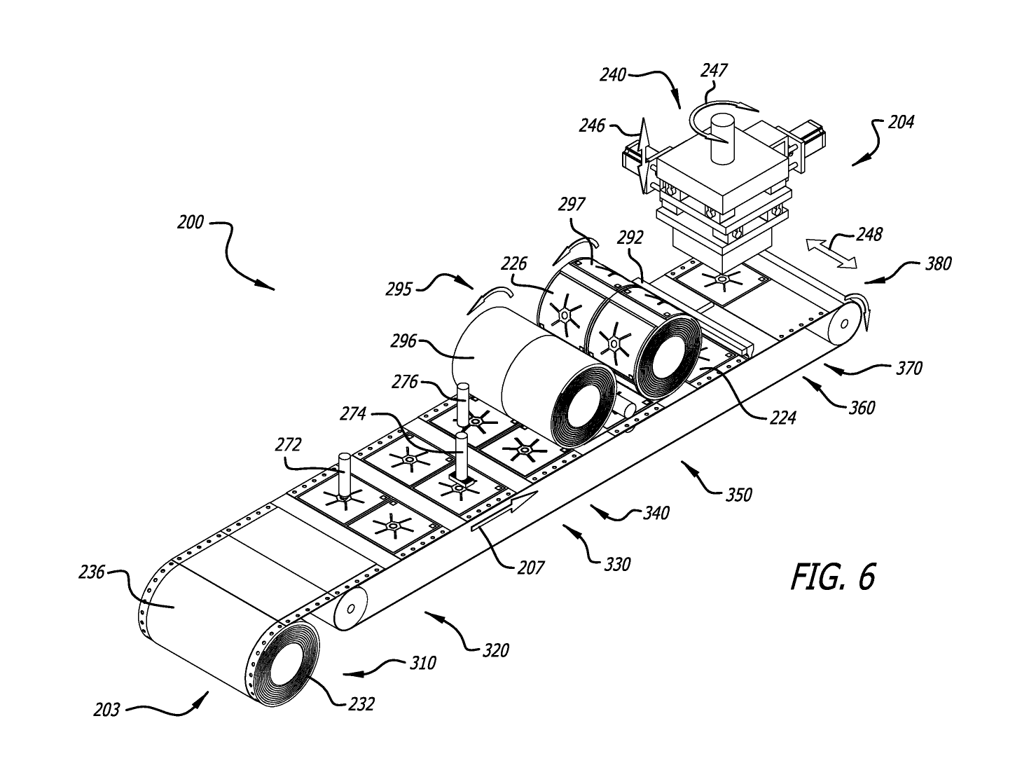

Referring now to FIG. 6, an example process for the laminated object manufacturing apparatus 200 shown in FIG. 5 includes selectively depositing adhesive inside the boundaries of individually contoured laminations 224 containing waste material, with the subsequent removal of the waste material contours 226 using a weeding mechanism 295. The cutting, adhesive deposition and waste removal steps occur concurrently on different lamination contours. This embodiment of the present inventive method includes the following steps: First 310, a continuous length (supply sheet) of product material 236 is provided at the first end portion 203 of the apparatus and stabilized on a removable carrier sheet (substrate) 230 (vacuum electrostatic or magnetic conveyor or table) and is bonded to the sheet of product material using a light adhesive force, such that the carrier sheet containing the product material moves (arrow 207) from an unwind (supply) roll 232 into a rewind roll (see FIGS. 1-4). Second 320, a cutting device (for example, a knife or laser) 272 capable of forming contours in the product material supply sheet without substantially damaging the carrier sheet (kiss-cut) is provided on an XY platform (see FIGS. 1-4) and configures the product laminations formed on the supply sheet so as to be in registration with a stacking platform 244 operably connected to a computer-controlled alignment mechanism 240 at a second end portion 104 of the laminated object manufacturing apparatus. Cutting the outlines of a plurality of contoured laminations distributed both along and across the product material sheet and carrier sheet is performed through the depth of the fabrication sheet without damaging the carrier (substrate) sheet, thereby separating the supply sheet into contours of individual laminations and adjacent contours composed of the waste material. Third 330, using a print head 274 (similarly disposed on an XY platform) to add ink or other colored material to one or more of the sequential contoured laminations. The Fourth 340 step includes selectively depositing adhesive on the carrier sheet within the boundaries of each contoured product lamination by using an adhesive deposition device 276 also disposed on an XY platform. Depositing adhesive within the contours containing waste is performed such that the adhesive being at a minimum deposited in a continuous line or closely spaced spots within a narrow region adjacent to the internal boundary of each contour of that waste. The narrow regions having their width being less than five percent (5%) of the width or length of an individual contour where they are located.

With continued reference to FIGS. 5 and 6 an the steps of the present process embodiment, the Fifth step 350 uses a weeding sheet (tape) 296 movable between an unwind roll 297 and a rewind roll 298 that are located between the cutting and stacking stations, wherein the weeding tape is maintained in frictional contact with the top surface of the fabrication material 236 so that advancing the carrier sheet 230 from its unwind roll 232 to its rewind roll (arrow 207) causes the advance of the weeding tape in the opposite direction (arrows 208) from the movement of the carrier sheet. Advancing the weeding sheet material from the unwind roll to its rewind roll activates the adhesion material in the waist contours onto the weeder tape, causing the waist contours to be peeled off of the carrier sheet onto the weeder tape. Optionally, the weeding ribbon may be pressed against a moving ribbon or solid surface. The Sixth 360, is optional and includes flowing (squeezing) a material, such as molten plastic or other dissolvable material into the spaces with the individually contoured laminations that were vacated by the peel-off contours. Step Seven 370 is also optional, wherein one or more abrasive rollers and/or solvents are used to remove residue of refill material from the top of the individually contoured laminations.

A shown inn FIGS. 5 and 6, the Eighth and step 380 brings each individually contoured lamination 224, having been freed from the waste material 226 previously surrounding the lamination, into contact with the laminating platform 244 or other contoured laminations previously bonded onto the lamination platform. The data from the scanner 292 is used by a computer, drive motors and/or other device to adjust the position of the stacking station 240 so that each sequential contoured lamination is in precise alignment to and bonded to each other lamination on the stack. Lastly, the carrier sheet (substrate) is peeled away the from the last contoured lamination bonded to the other laminations stacked on the lamination platform. This process of the present invention includes repeating the cutting, adhesive deposition, weeding, bonding, and peeling steps until the construction (lamination) of a desired three-dimensional object is complete.

Referring now to FIG. 7, and as discussed heretofore with reference to FIGS. 5 and 6, an embodiment of the process of the present invention includes depositing adhesive within contours of the waste material 226. The adhesive is deposited along trajectories that follow the boundaries of the waste material along the outside edges 227 of the individually contoured laminations 224 cut into the product material disposed on the carrier sheet 230. This strategy assures that no matter how complex is the geometry of a given lamination contour, the waste material will be peeled off the carrier sheet by the tape of the weeder mechanism 240 (FIG. 5). Similarly, registration markers 225 may be formed in the product material and adhesive applied to the edges of the registration markers. Optionally, a rectangular boundary 229 surrounding the product material may be used for adding refill material and/or for registration of the lamination contours during the stacking steps.

As shown in FIG. 8, an embodiment the method of the present invention includes forming the contoured laminations 324 in an array distributed both along (arrow 307) and across (arrow 348) the fabrication sheet 336. The cutting device 372 and the adhesive deposition device 376 may operate concurrently on sequential laminations. In this embodiment of the laminated object manufacturing apparatus 300, the weeder tape 296 removes internal portions 326 of the object, thus, creating a mold 350 when the contoured laminations are bonded and stacked. If the fabrication material is such that it can be dissolved, then the mold can be filled with a desired object material. After the object material is deposited into the mold, the fabrication material is dissolved with a suitable solvent. The filling of the contoured laminations with the molded material can be done either as a part of the machine's working cycle or as a separate step performed outside of the machine.

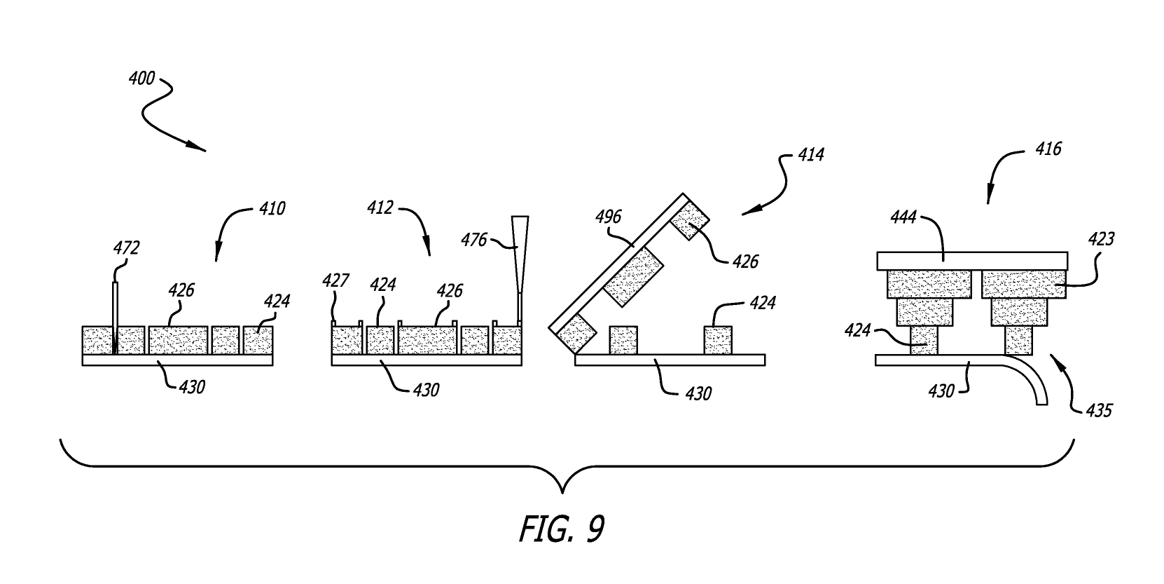

Referring now to FIG. 9, an alternate process 400 of the present invention uses a sheet of fabrication material that contains magnetized or magentizable metallic powder particles that attracts the fabrication material to a magnetic tape 430, a conveyor belt or a magnetic table. The metallic powder stabilizes the fabrication material during and after cutting the fabrication material into the contoured layers of a three-dimensional object. Thus, there is no need for lightly adhering the raw material to a sheet-based carrier as heretofore described. In this embodiment, one step 410 include using a cutting device (for example, a knife or laser) 472 to perform a ‘kiss-cut’ on the layer of product material to form the contours of lamination material 424 and waste material 426. In another step 412, a deposition device 476 sets down adhesive 427 along edges of the waste contours. Another step 414 contacts a peel-off (weeder) tape 496 against the waste contours, which bind to the weeder tape due to the deposited adhesive. A further step 416 of this method positions a lamination platform (plate) 444 so as to contact the stack of previously bonded contoured laminations 423 against the newly formed contoured laminations. The next step 416 in the present method separates 435 the magnetic strip from the contoured layers newly bonded to the stack.

An alternative method contemplated by the present invention includes selectively activating adhesive inside the boundaries of contours containing waste material, with the subsequent removal of the waste material by weeding. This method includes the following steps: (a) providing a continuous length of sheet material stabilized on a removable carrier sheet-substrate bonded to the sheet material with a light adhesive force, this material movable from an unwind roll into a rewind roll; (b) providing a cutting device configured to cut the supply sheet without substantially damaging its carrier: (c) providing a stacking platform and a mechanism for its computer-controlled alignment with the contoured laminations formed on the supply sheet; (d) providing a weeding tape movable between its own unwind and rewind rolls and located between the cutting and laminating devices, wherein the weeding tape is maintained in a frictional contact with the top surface of the fabrication material so that advancing the supply sheet from its unwind to its rewind roll causes the same advance of the weeding tape, wherein the weeding tape or the supply sheet is pre-coated on the surface where the contoured laminations contact with a light-activated adhesive or having a property of being able to adhere to each other lamination when heated while in contact with each other lamination: (e) providing an adhesive activating device that is located opposite to the area where weeding tape overlaps with the supply material, this area located between cutting device and the stacking platform; (f) cutting the outlines of a plurality of layers distributed both along and across said sheet, wherein the cutting is performed through the depth of the fabrication sheet without damaging the carrier or substrate and separating the supply sheet into contours of individual laminations of product material and adjacent contours composed of the waste material; (g) advancing that sheet so that the tape of the weeder mechanism overlaps the cut contours of the fabrication sheet: (h) activating adhesive within contours containing waste and also located within regions where the weeding tape overlaps the supply sheet, wherein the adhesive being at a minimum activated in a continuous line or closely spaced spots within a narrow region adjacent to the internal boundary of each contour of that waste, wherein these narrow regions having their width being less than five percent (5%) of the width or length of an individual contour where they are located; (i) advancing the sheet material from the unwind roll to its rewind roll, thus, causing waste contours that become adhered to the weeder tape through the selective adhesive activation to be peeled off onto the weeder tape.

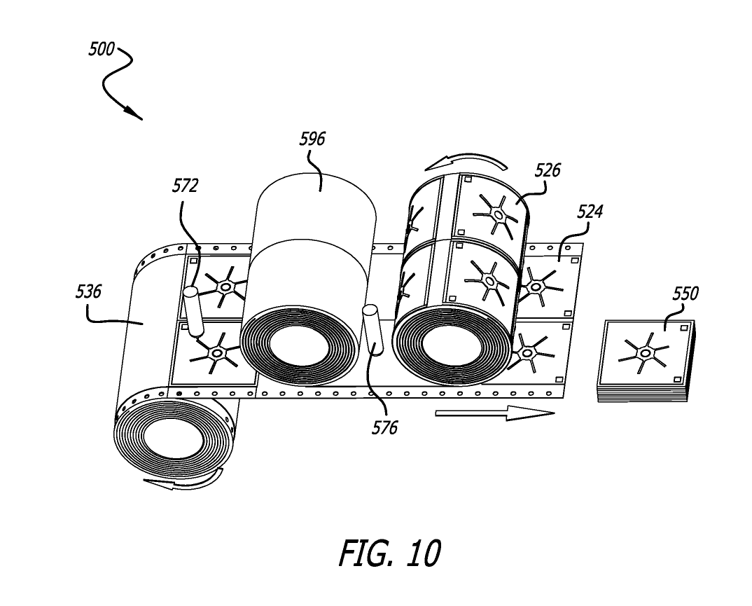

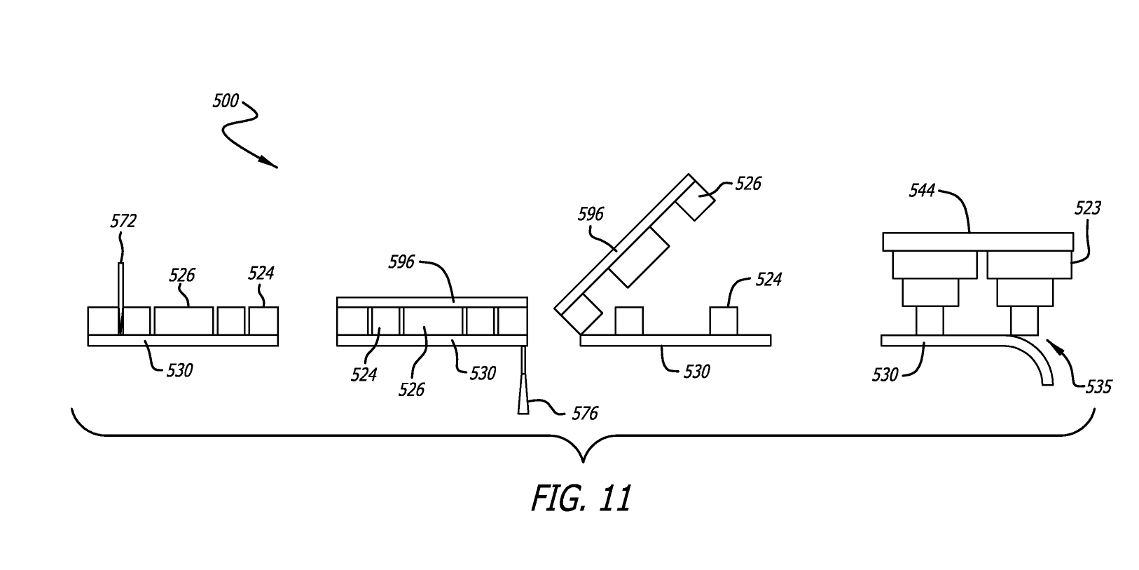

As shown in FIGS. 10 and 11, the present invention contemplates another approach to using a laminated object manufacturing apparatus 500 for bonding contours of waste material 526 to a weeder tape 596. This embodiment of a method of the present invention avoids depositing adhesive onto the fabricating sheet of product material 536. As heretofore described, a cutting device (for example, a knife or laser) 572 is used to perform a ‘kiss-cut’ on the layer of product material to form the contours of lamination material 524 within the waste product material. In this process embodiment, the contours of the waste material are bonded to the weeding tape by a welding tool (beam) 576. As explained herein with respect to adhesive bonding, the welding step selectively connects the peel-off weeder tape to the contours of the waste material so as to preferentially include areas adjacent to the boundaries of the waste-containing contours. The waste material contours are subsequently removed from (peeled off) 535 a carrier sheet 530 by the weeder tape. As heretofore described, a lamination platform (plate) 544 is positioned to contact a stack of previously bonded contoured laminations 523 against the newly formed contoured laminations. Next, the carrier sheet is separated 535 from the contoured laminations newly bonded to the stack 550.

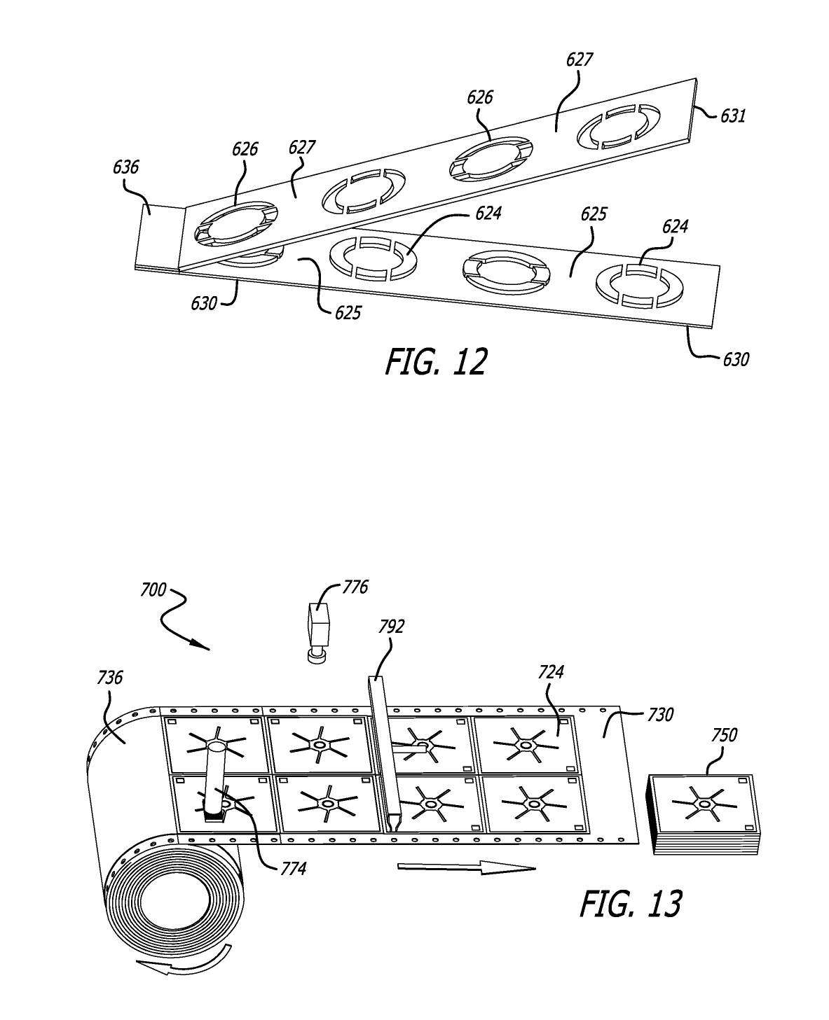

As illustrated in FIG. 12, each waste material contour 626 may be formed so as to be connected to each other waste contour with ‘tabs’ or ‘mats’ 627 of product material. Thereafter, the waste-containing outer portion of the fabrication sheet 631 is peeled off the carrier sheet 630 at a weeding station of the laminated object manufacturing machine. As heretofore described, the formed contoured laminations 624 remain on the carrier sheet. The empty spaces 625 created by the connecting waste material tabs or mats can change their orientation within the formed three-dimensional object. Alternatively, the contoured laminations may be connected with tabs or mats on the fabrication sheet so that when the fabrication sheet is peeled off the carrier sheet the waste material contours remain on the carrier sheet. Accordingly, when consecutive individually contoured laminations are attached to one another, the three-dimensional object does not fall apart and maintains its integrity with its shape minimally affected by the cuts on its surface.

The method for forming the connected waste material contours 626 depicted in FIG. 12 includes the following steps: (a) providing a continuous length of product sheet material 636 stabilized on a removable carrier sheet-substrate 630 bonded to the product sheet material with a light adhesive force, wherein the product material is configured to move from an unwind roll into a rewind roll; (b) using a device capable of and configured for cutting the product material without substantially damaging the carrier sheet (see FIGS. 5 and 6); (c) cutting the outlines of a plurality of contoured laminations 624 distributed both along and across the product material and carrier sheet, wherein the contoured laminations are formed so that all of the contours of waste material surrounding the lamination material are fully connected to each other waste material contour with waste material ‘tabs’ 627; (d) the cutting of the waste material is performed through the depth of the fabrication material sheet without damaging the carrier sheet substrate so as to form the product material supply sheet into contours of individual layers and adjacent contours composed of connected waste material; (e) peeling the waste material ribbon containing each of the connected waste material contours away from the carrier sheet containing the individually contoured product laminations; (f) using a computer-controlled stacking platform to align the spaced 625 contoured laminations formed on the carrier sheet.

With attention to FIG. 13, an alternative embodiment of a method and an apparatus that can potentially be very fast and efficient includes providing product (supply) material formed from a water-soluble or chemically-soluble sheet 736. In this ‘etching’ process, a protective mask of light-curable adhesive can be printed to provide a contoured lamination 724 onto the upper surface of the fabrication material by a print head 774. The contoured lamination is subsequently cured, for example, by an ultraviolet (UV) or other light emitting (curing) source. In this process, the printed geometry should cover the contours representing a individually contoured layer of the manufactured object. These contours are desired to remain on the carrier sheet 730 after the fabrication material is subjected to dissolving action of water or a solvent, for example, an acid to dissolve a metal. There are several other well-known methods used for achieving the same goal. These methods are used in the industrial “chemical etching” process and include exposing the fabrication sheet coated with a UV curable adhesive though a design pattern printed on a masking tape or projecting light from a digital light processing (DLP) projector 776 in a pattern of the desired layers. After this masking step has taken place the material supply sheet (ribbon) is subjected to a dissolving agent (such as water or a suitable solvent) from a spray nozzle 792. This step removes the material of waste surrounding the contoured lamination layers. After the waste material is removed, the protective layer of the UV curable material may be removed from each individually contoured layer.

This ‘etching’ method embodiment of the present invention includes the following steps: (a) providing a supply sheet of chemically-soluble or water-soluble product material 736 stabilized on a removable carrier sheet-substrate 730 bonded to the sheet of product material with a light adhesive force; (b) masking the portions of the product material sheet with a protective mask representing and forming the individually contoured laminations 724 of the desired manufactured object; (c) dissolving the material in the unprotected areas; (d) providing etching or dissolving means capable of etching or dissolving the unprotected sheet without substantially damaging the carrier sheet; (e) forming protective masking over the regions representing a plurality of the object's contoured lamination that are distributed both along and across the carrier sheet; (f) etching or dissolving (in water or other suitable solvents) the material surrounding the contoured laminations without damaging the carrier sheet (substrate); (g) using a computer-controlled stacking platform for alignment with the contoured laminations formed on the supply sheet.

Another aspect of the present invention a process for forming contoured laminations of product material using additive 3D-printing techniques. This alternative embodiment includes the following steps: (a) providing a continuous length of a carrier sheet capable of bonding to materials deposited on to the carrier sheet with a light adhesive force, wherein the carrier sheet is movable from an unwind roll into a rewind roll; (b) using devices and mechanisms known in additive 3D-printing technologies to form an array of sequential thin contoured laminations for constructing a three-dimensional object on the carrier sheet; (c) performing and repeating material refilling, stacking and sacrificial mold removing steps.

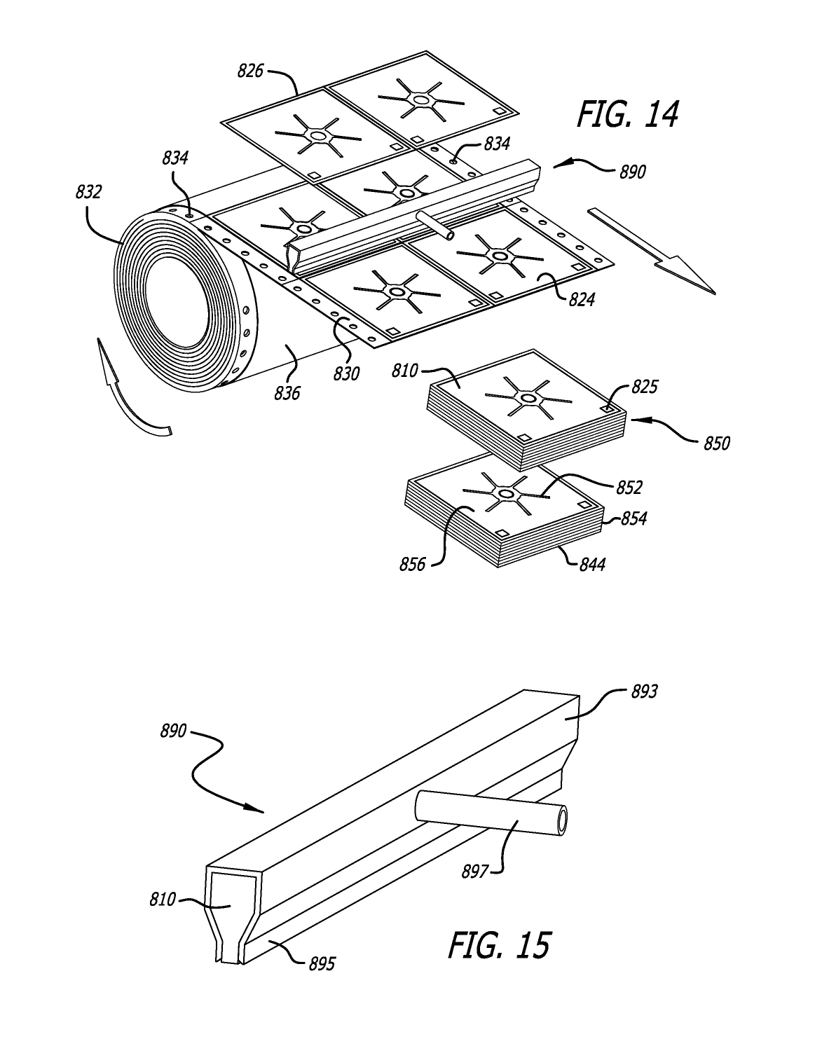

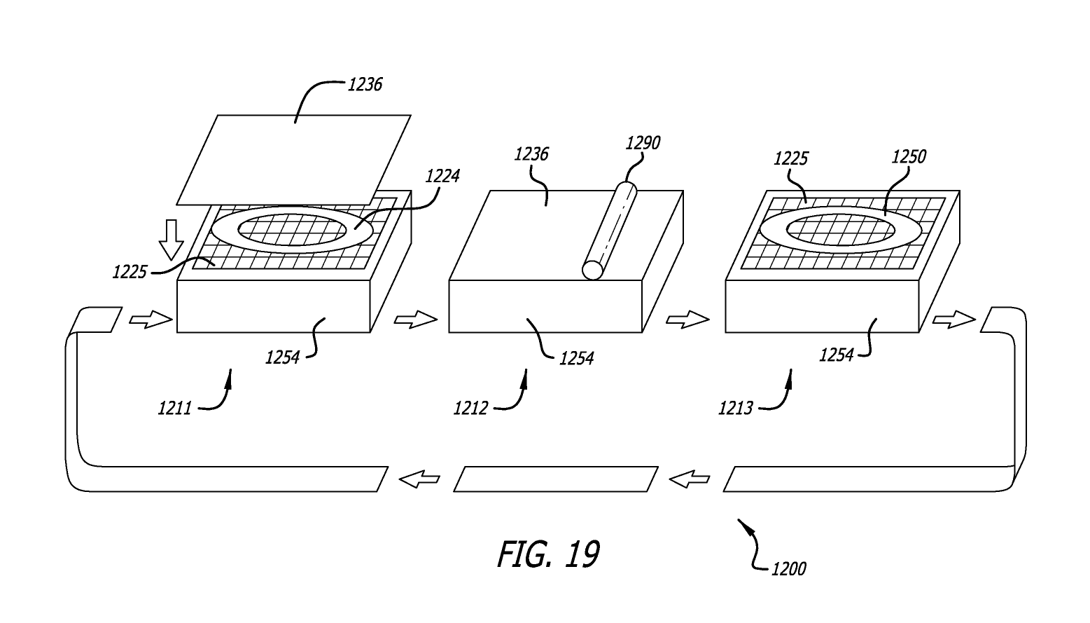

Referring now to FIGS. 14-18, another aspect in accordance with the present invention is directed to forming contoured laminations of a three-dimensional object free of waste material on a carrier sheet and then refilling the individually contoured layers with another material. This method includes the following steps: (a) forming a plurality of thin waste-material-free contoured laminations 824 in an array along and across a removable carrier sheet 830, wherein the contoured laminations represent sequential cross-sections of a three-dimensional object 852 and the carrier sheet is bonded to the contoured laminations with a light adhesive force; (b) using a nozzle 890 (see FIG. 15) for refilling a space 856 surrounding the contoured lamination with another (sacrificial) material 810 capable of holding each unsupported individually contoured lamination together and capable of maintaining the integrity of an individually-formed lamination after the contoured lamination has been peeled away from the carrier sheet; (c) applying sacrificial material to refill the space surrounding the individually contoured laminations formed on the carrier sheet; (d) using a leveling device 895 for insuring that the top surface of the refilled material and the top surface of the formed laminations is the same and is parallel to the carrier sheet (see FIG. 19); (e) cutting a boundary 854 through the refill material and around the contoured lamination so as to separate each contoured lamination on the carrier sheet from each other lamination on the carrier sheet; (f) providing a stacking (laminating) platform 844 and an alignment mechanism 825, 834 for precise registration of a contoured lamination to each other previously stacked contoured lamination 850; (g) bringing each contoured lamination into contact with the contoured laminations previously stacked on the platform in precise alignment to them and bonding it to them (the first contoured lamination is brought into direct contact with the platform), wherein the bonding step is performed either for every consecutive lamination or for the entire stack of contoured laminations; (h) peeling away the carrier sheet substrate from the contoured lamination; (i) continuing the forming, bonding, and peeling steps until the construction of the desired three-dimensional object is complete; and (j) dissolving or otherwise removing the refilled sacrificial material from the stack of bonded contoured laminations

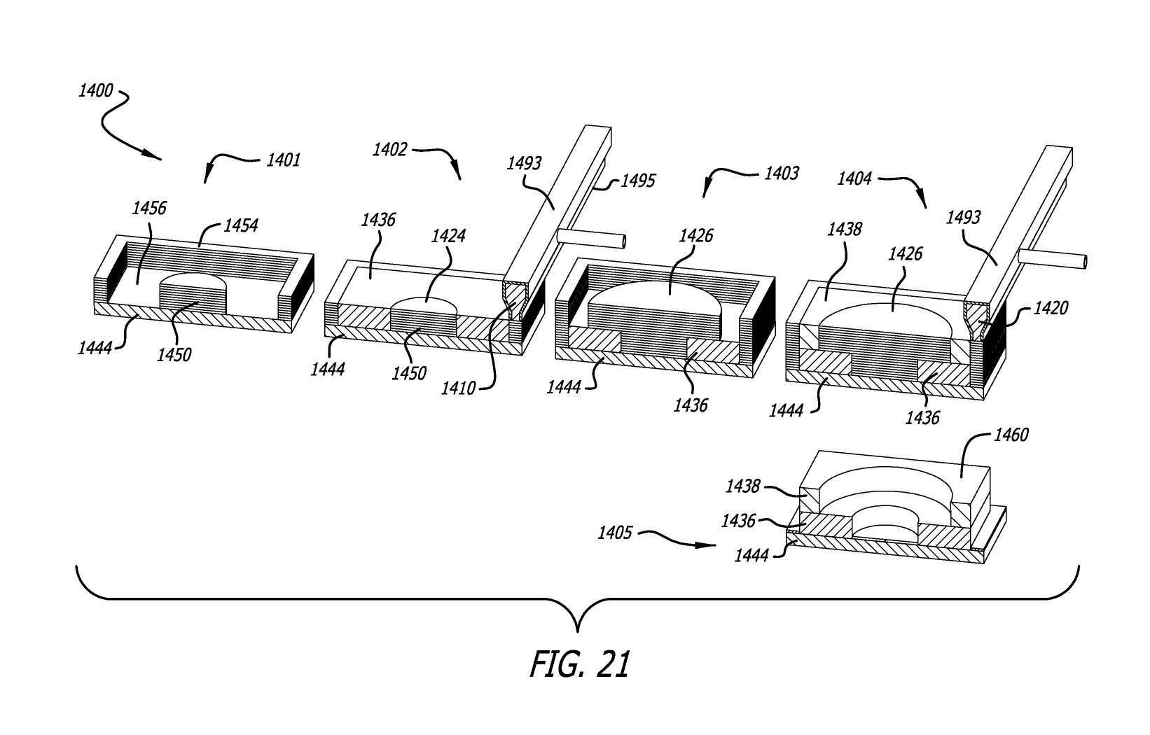

Alternatively, since the sacrificial material 810 fully connects each individually contoured lamination 824, the carrier sheet 830 may be peeled away (removed) from the bounded contoured lamination before assembling the laminations 850 on the stacking platform 844. Conversely, the contoured laminations may be dissolved (removed) so that the refill material forms the desired three-dimensional object or forms a mold for manufacturing a three-dimensional object (see FIG. 21).

The apparatuses and methods described herein with reference to FIGS. 1-13 are directed to producing waste-free layers distributed on a removable carrier ribbon. A support structure, however, needs to be designed into a three-dimensional object manufactured in a layer-by-layer fashion. This inconvenient requirement can be avoided if a method creates an object in a “fully-supported” three-dimensional printing process. In a “fully-supported” process, each contoured lamination (layer) of a manufactured object is surrounded with contours of a sacrificial material, which serves as a support structure for the manufactured object. After the three-dimensional object has been laminated, the support structure is dissolved.

Referring again to FIG. 14, the spaces 856 formerly occupied with waste material 826 are refilled with sacrificial material 810 to surround the contoured laminations 824 formed on the carrier sheet 830. The refill material may serve the function of a sacrificial support structure or, if the fabrication sheet is water-soluble or chemically soluble, then the refill material will form the desired three-dimensional object 852. The refill process can be accomplished by a flat nozzle 890 having a material inlet port 897, as illustrated in FIG. 15. For example, the nozzle may be configured for extruding a flowable thermoplastic material into the spaces between the formed lamination laminations. The flowable material can also be a metal or ceramic powder or slurry, or a curable epoxy, or rubber or any other substance that can be solidified after flowing into the spaces surrounding the formed contoured laminations. As is known to those skilled in the art, the nozzle can also include heaters to keep the thermoplastic in a molten state. Additional heaters can be located underneath the fabrication sheet. Alternatively, infrared heaters can be configured to direct their heat towards the refilled portions of the fabrication sheet, while each individually contoured layer is being refilled. The heaters may be configured to maintain an elevated temperature in each lamination to assist the refill process and to avoid untimely solidification of the refill material once the material has been deposited. This heating will assure relatively low viscosity of the refilling material during its deposition.

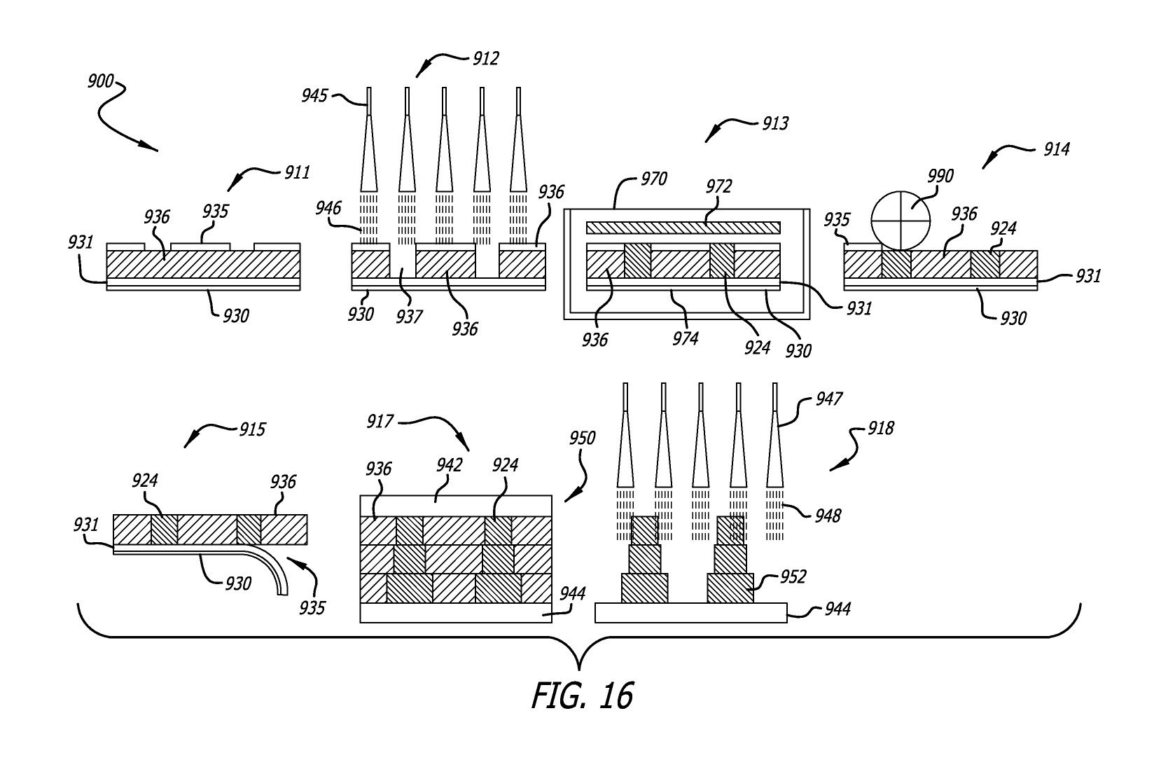

As shown in FIG. 16, the present invention includes a process 900 (contoured lamination forming and refilling steps) for manufacturing a metal part. In this technique, the initial staring materials are a metallic sheet (ribbon) 936 adhered with a light force onto a carrier sheet (ribbon) 930 having an insulating layer 931 positioned between the carrier sheet and the metal ribbon. The process of this embodiment of the present invention includes the following steps: (a—911) depositing a mask 935 over the metal ribbon, for example, a mask formed from an ultraviolet absorbing material or a sand blasting mask; (b—912) chemically etching the metal ribbon by using one or more nozzles 945 to spray an acid or other chemical 946 onto the mask and metal ribbon to form a contoured lamination layer, wherein the etching process alternatively may be accomplished using a sand blasting device to remove the metal not protected by the mask; (c—913) using an electro-deposition mechanism 970 for refilling deposition metal 924 into the spaces 937 between the remaining metal ribbon portions 936 formed by the etching process, for example, positioning the contoured lamination on an anode 974 and below a cathode 972 of deposition metal; (d—914) using a grinder 990 to level upper portion the contoured lamination of metal ribbon 936 and deposition metal 924, whereby the mask material is removed; (e—915) cutting the contoured lamination of metal ribbon and deposition metal into individual cross-sections so as to remove the insulated carrier sheet: (f—916) using a grinder 992 to level bottom portion the formed contoured lamination of metal ribbon and deposition metal; (g—917) stacking and bonding the each contoured lamination of metal ribbon and deposition metal together, for example, performing a diffusion process by sequentially placing each contoured lamination on a lamination platform and compressing the laminations together using a pressure plate 942; (h—918) spraying an acid or other chemical 948 from one or more nozzles 947 onto the stack 950 of contoured laminations to remove the remaining metal ribbon portions to expose the layers of deposition (refill) metal, thereby revealing the final part or assembly 952. Alternatively, the chemical spray nozzles may remove the refilled deposition metal so that the desired object is formed from contoured laminations of the original metal ribbon.

The present invention also contemplates multiple lamination-forming and material-refilling stations distributed along the fabrication material ribbon as the material ribbon is advanced on the carrier sheet. In such an embodiment of the present invention, the steps of lamination forming and refilling can be consecutively repeated several times for each lamination, such that the contours in the lamination are refilled with a different material at each station. Once bonded, these laminations will form a multi-material part or an assembly. This part or assembly can be freed from the support structure surrounding it once the sacrificial material composed of the laminations of the fabrication sheet has been dissolved.

Another method for forming layers or a three-dimensional object out of sheets or films can be carried out by utilizing a sand blasting or sand-carving technique similar to water or chemical etching. In such an embodiment, the contoured lamination is formed from the fabricating sheet by sand blasting through a protective mask. This sand blasting (carving) process works identically to the chemical or water etching technique described herein and illustrated on FIG. 16.

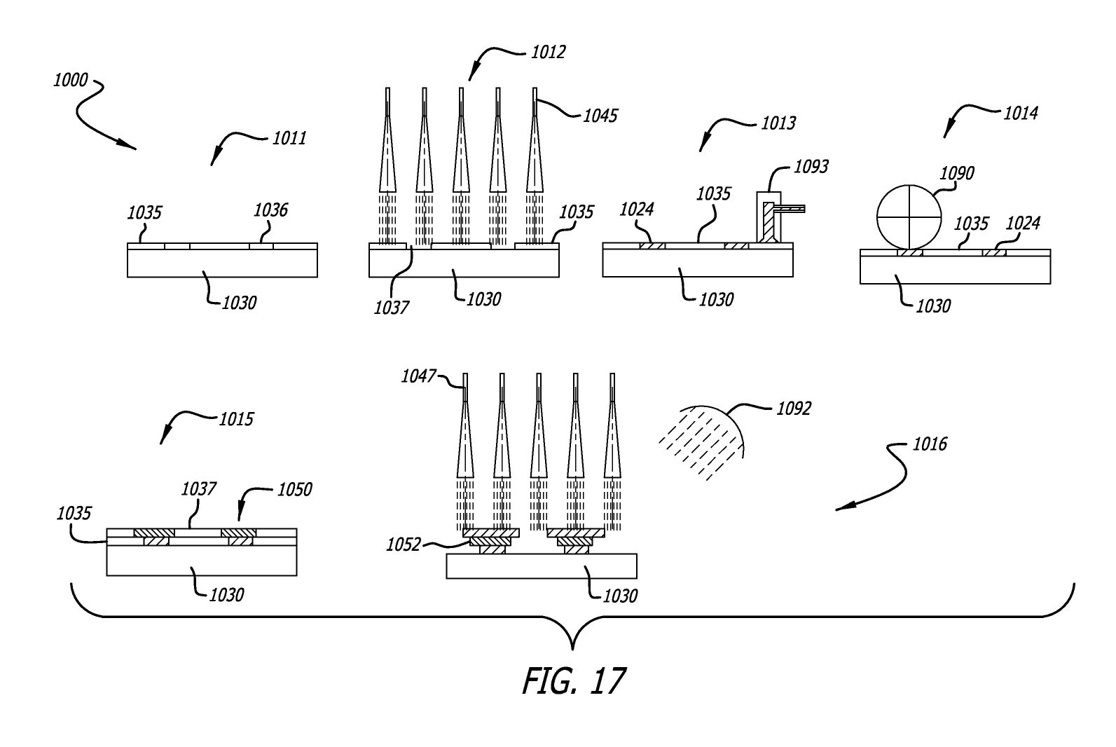

Referring now to FIG. 17, another process 1000 of the present invention forms laminated plurality of contoured laminations used to construct a three-dimensional object from a sandblasting mask or from a manufacturing sheet material covered by a sandblasting mask. A three-dimensional object 1052 made from such a mask or the sand blasted sheet material can be used as a sacrificial mold for manufacturing an object from a plastic, metal or ceramic. The process includes the following steps: (a—1011) attaching a sandblasting resisting sheet 1030 to a sandblasting mask 1035 having portions 1036 previously exposed to ultraviolet light so as to form contoured laminations, or attaching a sandblasting mask to a sandblast (fabrication) sheet or film material to form the contoured layers; (b—1012) selectively removing the ultraviolet light exposed portions of the sandblasting mask (film) by ablating the mask with a sandblast device 1045, wherein at this stage the sandblasted mask can be stacked into a three-dimensional part utilizing stacking methods previously described herein; (c—1013) using a refill nozzle 1093 to refill the vacated spaces 1037 with a plastic or another flowable refill material, or to refill the vacated spaces using an electro-deposition process; (d) leveling the sandblasting mask (film) and refill material with a grinding (leveling) mechanism 1090 so that the refilled portions 1024 of the contoured lamination are equal in their thickness to the original fabrication sheet (if so desired, at this stage in the manufacture process the refilled fabrication sheet can be split into individual contoured laminations, which are later stacked together, bonded and freed from the refill material); optionally (e—1015) attaching another mask or a mask covered film 1037 to the first formed contoured lamination, and repeat the prior steps until each of the contoured lamination are in a stack 1050 to form the three-dimensional object 1052; (f—1016) after the stack 1050 of contoured lamination of the three-dimensional object have been added in this manner, a second ablating device 1047 is used to remove the sacrificial mold. The sacrificial mold may be removed by dissolving the mold in a solvent or breaking the mold if the mask is formed from a fragile material. Further, a ultraviolet light emitting device 1092 may be used to cure the refill material.

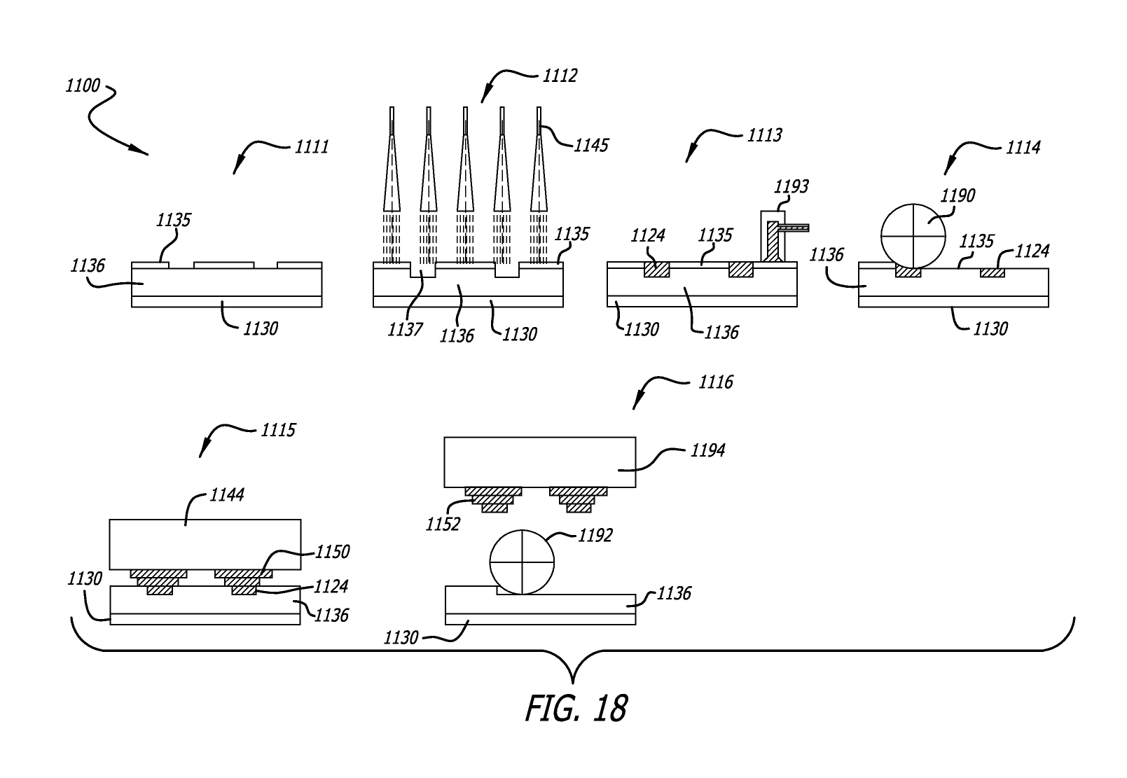

Another way to utilize a sand-carving process 1110 for manufacturing three-dimensional (3D objects) is illustrated in FIG. 18. In this embodiment of a process of the present invention, the steps are as follows: (a—1111) cover a block of a sand-blast formable material 1136 with a UV-exposed sandblasting mask 1135 containing the design of the individual contoured laminations to be formed from the formable material, wherein the formable material is adhered with a light force onto a carrier sheet (ribbon) 1130; (b—1112) sand blast the mask and the block of formable material: (c—1113) refill the spaces 1137 vacated by the sand blasting with a flowable material, or refill using another process as described herein: (d—1114) level the block of formable and refill material and remove the masking layer: (e—1115) separate the refilled contoured laminations 124 from the formable material block and sequentially attach the contoured laminations to a stacking plate 1144 in precise registration to each other contoured lamination using heat, adhesive or solvent bonding: (f—1116) after the contoured laminations have been collected and stacked 1150, level the block of formable material 1136 with a grinder 1192 and continue performing the prior steps until the manufacturing of the 3D object 1152 has been completed.

The process of refilling with the flowable material 1124 can be performed by one or more nozzles or nozzle assemblies 1193 located over the advancing fabrication sheet material 1136. As shown in FIG. 15, these nozzles or nozzle assemblies may further include an edge or a roller covering the width of the fabrication sheet and maintaining contact with the fabrication sheet while fabrication sheet is in relative motion to the nozzles. The purpose of this edge or a roller is to perform functions similar to a mason blade. The roller is intended to squeeze the flowable material into the space between the formed contoured laminations. The leveling roller can also be actively driven in a counter-rotating motion with respect to the natural rotation caused by its engagement with the moving sheet of fabrication material. The nozzle is may be a flat nozzle spanning the width of the fabrication material.

In the method 1100 of the present invention shown in FIG. 18, the fabrication sheet 1136 may be formed from a metal foil and the refill material 1124 may be another metal deposited electrochemically. Alternatively, another metal can be delivered in the molten form out of the refill nozzle 1193. When metal sheets are used as a raw material, the laminations can be formed by chemical etching. The refilling step can be followed by using a device, for example, a grinder, 1190 that levels the entire width of the refilled foil as the fabrication sheet advances under the grinder. After the 1120 lamination laminations have been stacked the laminations may be fused together by a diffusion bonding process under high pressure and temperature. After the laminations may be fused together, one of the metals may be chemically dissolved. Other desirable raw materials usable for such a fabrication process include sheets of regular or green ceramics. The ceramics can be cut by a laser beam or a knife, and the ceramics will resist the high temperatures of the molten metal when the vacated spaces 1137 are refilled.

Using a water-soluble or solvent-soluble carrier sheet may be advantageous in the method for forming contoured laminations using additive 3D-printing techniques in combination with the refill methods described herein. In such an embodiment of the present invention, “protective masking” required for forming contoured laminations using additive 3D-printing can be performed within the areas that define contours of the waste material surrounding the contoured laminations used to construct the manufactured object. As is described herein, this step in the LOM process may be performed by selectively solidifying a pattern of UV (ultraviolet) or another light-curable material on the surface of a water-soluble carrier sheet prior to dissolving uncovered portions of the sheet with a water-based liquid. This step is performed similarly to the sheet-metal forming method known as “chemical etching.” The selective solidifying among other well know methods in this field can be performed through a xerographically produced mask or by a DLP projector, which projects patterns of light corresponding to the contoured laminations onto the water-soluble sheet material coated with a light curable polymer. The “refilling” step can be performed with a plastic material such as, but not limited to, ABS or polycarbonate, or Styrene. If the carrier sheet is made out of refractive ceramic-based power sheet, then molten metal may be suitable. When ceramics and metals are used, once the laminated stack has been fused together by heat and pressure, or by an adhesive or solvent-bonding, the sacrificial laminations are dissolved, sand blasted away or otherwise removed. The remaining integral object will be rendered out of the desired high-quality non-porous plastic.

Similar to the process described above, a thin layer of ceramic or metal powder filled UV curable epoxy can be deposited over a carrier sheet and UV cured through exposure to a pattern of light projected from a DLP projector. In such a process, the cured material will form the refillable contoured laminations or the sacrificial mold. After the exposure the unexposed portions of the carrier sheet can be washed away. Then the refill and the removal of the sacrificial mold can be conducted as described herein.

As is shown the FIG. 19, both in the “cut-before-bond” or “bond-before-cut” laminated object manufacturing (LOM) process 1200 it may be desirable to form a rectangular boundary 1254 or another repeatable shape boundary around near the formed contoured laminations 1224. It may also be important to form or leave registration marks 1225 on the lamination material 1236. The registration marks can be used by a laminated object manufacturing machine (apparatus) to precisely register the contoured laminations by a stacking-bonding mechanism 1290. The rectangular boundary or its features can stabilize the object during stacking and can also be used for the registration of the layer stack 1250. The process repeats the steps of adding 1211 a layer of product and waste (sacrificial) material, bonding 1212 the lamination layer to the stack and cutting 1213 the stack until formation of the desired three-dimensional object is completed.

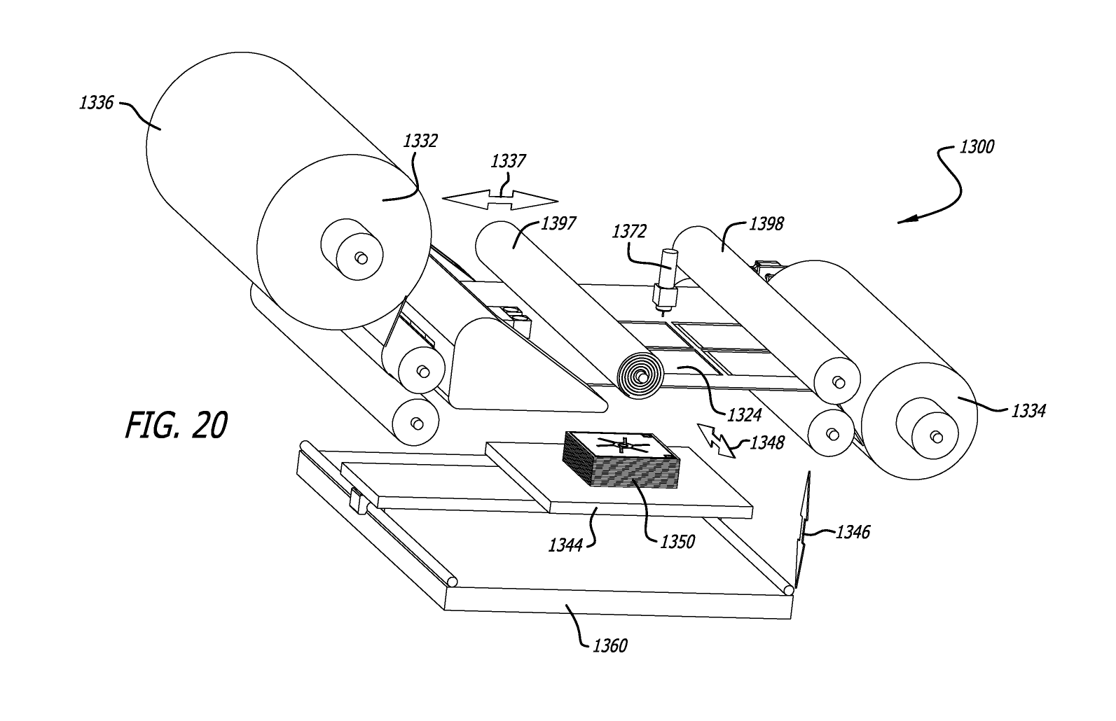

As shown in FIG. 20, a “bond-before-cut” LOM system 1300 in accordance with an alternative embodiment of the present invention includes a stacking platform 1344 configured to move across the sheet of lamination material 1336. The ribbon of lamination material moves 1337 from a feed roll 1332 to a take-up roll 1334. Similar to the proposed “cut-before-bond” systems described herein, the stacking platform of this machine is configured to have lateral movement 1348 across the ribbon and supported by a vertical moving 1346 stage 1360. In this process, the entire width of the fabrication ribbon can be utilized in order to make small or large parts. For small parts, the contoured laminations 1324 may be formed from the portions of the fabrication ribbon distributed both along and across the ribbon, thus minimizing the waste generated by the production process. This embodiment of the LOM system may optionally contain a color printer, which can add color to the produced 3D objects. Additionally, an ink or another adhesion reducing substance can be deposited by the apparatus onto the waste portions or onto the laminations surrounding the contours comprising the manufactured object. The adhesion reducing substance is provided to weaken the bond of the material surrounding the part and enhance the removal of the waste material that does not belong to the manufactured part at the end of the process. At the same time, a multi-color design can be added to the object.

Referring now to FIG. 21, an alternative embodiment of the present invention includes building a 3D part using a multilayered refill method 1400. A flowable material 1410 can be used to fill 1402, 1404 the space 1456 within the contoured laminations 1424, 1426 that have previously been formed and stacked 1401 on the laminating platform 1444. The space between the stacked contoured laminations 1450 may be filled by using a nozzle 1493 similar to the one described herein (FIG. 15), wherein the nozzle is located above the surface of the lamination material 1436, 1438 and reciprocally movable over the stack and any boundary 1454 around the stack. The LOM apparatus for this manufacturing process can be instructed to add mold material 1410, 1420 to fill the spaces formed between repeated stacking 1403 of the contoured laminations. A scraping edge 1495 on the nozzle removes the excess refill material as the nozzle moves over the upper surface of the contoured lamination or laminations. This multilayered refill method is especially useful if a support structure formed 1405 from the laminations of refill material 1436, 1438 needs to be provided for the geometry of the part or mold 1460 being formed.

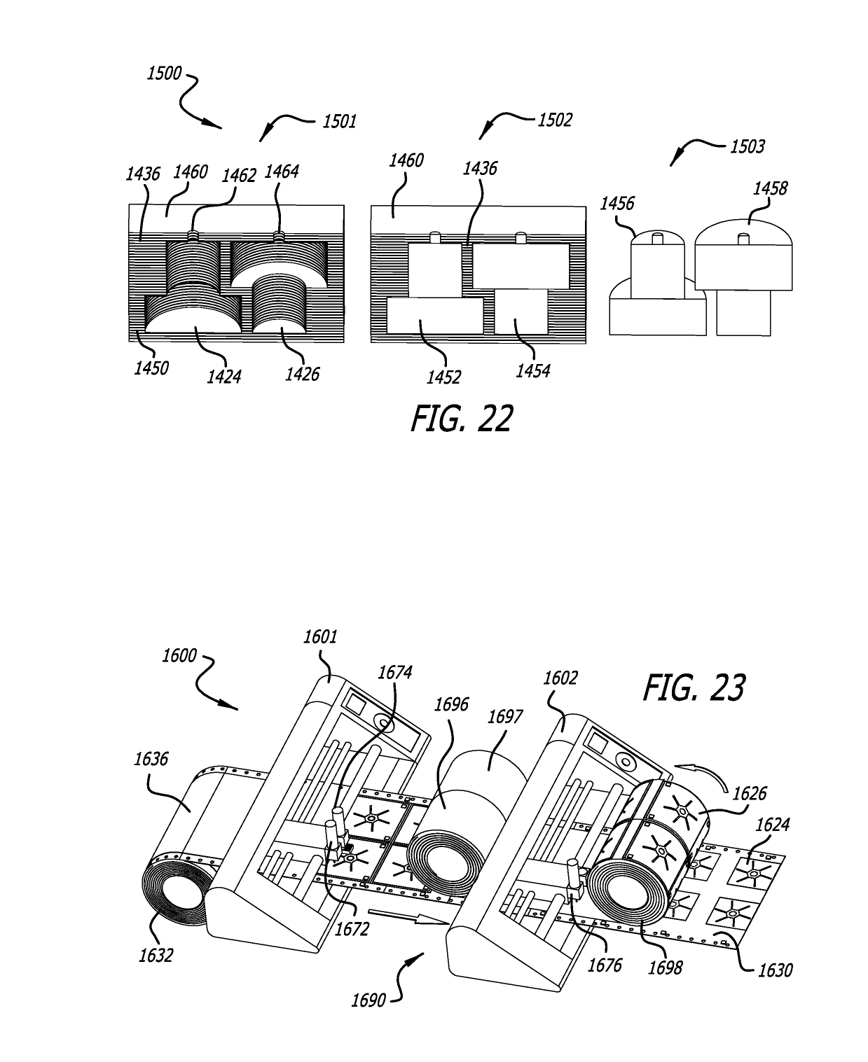

As illustrated in FIG. 22, the present invention includes a process 1500 for providing a multi-cavity sacrificial mold for multi-material parts and assemblies. When a three dimensional object is formed 1501 using water-soluble or solvent-soluble sheet material 1436, then the entire laminated object can be used as a sacrificial mold 1460. For example, the mold is first filled 1502 with a molten plastic, or a curable material 1452 or another flowable and further solidifiable material using inlet ports 1462, 164 in the mold, which may then be dissolved. Since unlike the traditional molding there is no need to open this mold, the mold can have several enclosed cavities 1452, 1454. Each cavity can be injected with the same or a different material 1454 used for making a multi-material assembly. The parts 1456, 1458 for the assembly will be revealed once the water-soluble mold has been dissolved 1503. Although a water-soluble mold may be the most environmentally attractive, other sacrificial molds can be formed out of sheets of wax, refractory sheets containing a large portion of ceramic particles (green ceramics), solvent soluble sheets made of plastic and metal. The sacrificial sheet material may possess higher melting temperature than the material that is used for the assembly parts. For example, if a metal is used for the assembly parts, then a ceramic or a metal of higher temperature may be used in the sacrificial mold.

Although a LOM process generates waste in the form of material surrounding individual layers, a LOM process generates comparatively less waste when used for creating a mold. Accordingly, using water-soluble plastic for making the earlier-described sacrificial mold represents a very attractive opportunity for the LOM technology. For example, using a LOM mold provides for construction of an object as complex as a leafy plant, or a flower, or a branch of a tree with tiny and fragile leaves hanging on it. Most of the existing 3D-printing processes, which require a support structure, will fail in producing such a model due to the share number of its unsupported elements. On the other hand, a sacrificial mold manufactured by the ‘Remove and Refill’ (FIG. 21) LOM process embodiment of the present invention will easily deliver such a complex part.

The possibility of using multiple stations simultaneously working on forming the contoured laminations of a part or constructing a 3D object is unique for the LOM process of the present invention. An alternative embodiment of an automated system utilizing this concept is shown in FIG. 23. The laminated object manufacturing apparatus 1600 employs two positioning devices 1601, 1602 that may be similar to widely used vinyl-cutters. The positioning devices may be configured from other types of XY positioners. The first positioner receives a ribbon (sheet, tape) of fabricating material 1636 lightly adhered to a carrier sheet 1630 and includes a cutting device 1672 and a printing device 1674. The sheet of fabrication material is used for cutting the material into an array of individual contoured laminations 1624 surrounded by contours of waste material 1626. The second positioner receives the ribbon of fabrication material from the first positioner. Inside of the second positioner, the fabrication tape is overlaid with a peel-off tape 1696 supplied from an unwind roll 1697 of a weeding mechanism 1690. The second positioning device manipulates a small laser or another source 1676 of focused light, which welds the weeding ribbon to the contours of waste material in the contoured manner described herein with reference to FIGS. 1 and 5. The second positioning device could also manipulate a hot pointed tool. The weeding ribbon may be coated with a light or heat activated adhesive. As the fabrication ribbon exits the second positioner and the weeder, the fabrication ribbon only contains an array of contoured laminations free of waste material.

Color is an important and desirable feature of 3D objects. Prior described methods for creating a color pattern on edges of a layer of a 3D object included printing the pattern on color transmitting or color paint-absorbing or ink-absorbing media. An alternative process in accordance with the present invention includes delivering color onto edges of cut or formed contoured laminations after the contoured laminations have been created. In such a process, the paint or ink should flow over these edges during the printing step. Thus, each of the described 3D object forming methods disclosed herein can include a step of printing color profiles corresponding to the color of the edges of each contoured lamination of the object over the edge-inclusive regions of these laminations after the contoured laminations have been formed, thus, enabling construction of a colored 3D object, even if the fabrication sheet is non-transparent, paint-absorbing or ink-absorbing.

The carrier sheet of the color pattern printing technology is an important component that must be chosen carefully. If a knife cutting is used for forming the contoured laminations, then a release material coated paper sheet must be thick enough in order to not be perforated during the cutting. If a laser is used, then a thin metal foil or a foil-laminated paper can serve as a carrier sheet. The fabrication ribbon (sheet) can be lightly bonded to the carrier sheet by a spray adhesive or another releasable agent.

The laminated object manufacturing apparatus and process of the present invention includes three alternative embodiments of methods that do not remove waste material surrounding cut layers prior to stacking them on the laminating platform. Instead, they utilize a process (“selective means”), for example, “selective adhesive deposition”, “selective adhesive activation” and “selective adhesive deactivation”, for assuring that only the material of the desired layer is attached to the stacking platform.

The first of these alternative embodiments of the LOM method of the present invention is directed to a process for selective adhesive deposition within the contoured lamination. The method includes the following steps: (a) providing a length of a fabrication material sheet stabilized on a removable carrier sheet bonded to the sheet of fabrication material using a light adhesive force, using a vacuum plate, or using a vacuum, magnetic or electrostatic conveyor so that unconnected portions of the fabrication sheet material remain in registration to one another independently of the motion or position of the carrier sheet or conveyor after the fabrication material surrounding each individually contoured lamination has been removed; (b) providing a device capable of cutting the fabrication material sheet without substantially damaging the carrier sheet: (c) providing a stacking platform and an operably connected mechanism for computer-controlled alignment with the contoured laminations formed on the fabrication material supply sheet; (d) cutting the outlines of a plurality of contoured laminations distributed both along and across the fabrication material sheet, wherein the cutting is performed through the depth of the fabrication sheet without damaging the carrier sheet, and wherein the fabrication material supply sheet is separated into contours of individual laminations and adjacent contours composed of waste fabrication material; (e) depositing adhesive within the contours of the contoured laminations, wherein the adhesive is at a minimum deposited in a continuous line or closely spaced spots within a narrow region adjacent to the internal boundary of each contour of each lamination, wherein these narrow regions have a width being less than five percent of the width or length of an individual contour where the narrow regions are located; (f) bringing each contoured lamination into contact with a laminating platform or other laminations on a laminating platform in precise alignment to each other lamination and bonding the contoured laminations together by applying pressure, applying heat and pressure, or using adhesive activating light through the carrier sheet; (g) peeling away the carrier sheet containing any unwanted fabrication material, and repeating the cutting, bonding and peeling steps until the construction of the three dimensional object is complete.

This preferential bonding within the narrow region adjacent to the internal boundary of each contour of a given lamination assures that the contour will be fully adhered to the stack. A more secure bond may be accomplished by performing this “selective bonding” step with a “general bonding” step applied over the entire surface of a contoured lamination. This combined bonding process can be performed on a layer-by-layer fashion or performed for an entire stack of formed and stacked laminations, for example, by compressing and heating the contoured lamination or by immersing the contoured lamination into a solvent.

The second of these alternative embodiments of the method of the present invention is directed to a process for “selective adhesive activation” within a contoured lamination. This second alternative method is very similar to the first alternative method, but instead of“adhesive deposition” this alternative method uses “selective adhesive activation” as a process for attaching each contoured lamination. The method of “selective adhesive activation” includes the following steps: (a) providing a length of fabrication sheet material stabilized on a removable carrier sheet bonded to the fabrication sheet material using a light adhesive force, using a vacuum plate, or using a vacuum or electrostatic conveyor so that unconnected portions of the fabrication sheet material remain in registration to one another independently of the motion or position of the carrier sheet or conveyor after the fabrication material surrounding each individually contoured lamination has been removed; (b) providing a device capable of cutting the fabrication material sheet without substantially damaging the carrier sheet; (c) providing a stacking platform and an associated mechanism for computer-controlled alignment with the contoured laminations formed on the fabrication material sheet; (d) cutting the outlines of a plurality of contoured laminations distributed both along and across the fabrication material sheet, wherein this cutting is performed through the depth of the fabrication material sheet without damaging the carrier sheet, and wherein the fabrication material sheet is separated into contours of individual laminations and adjacent contours composed of waste fabrication material; (e) if an adhesive assisted bonding of laminations is desired, depositing a UV curable or another light or heat activated adhesive over the top of the fabrication material sheet, or providing the fabrication material sheet having an adhesive deposited on the fabrication material; (f) sequentially bringing each contoured lamination into contact with a stacking platform or into contact with other laminations on a stacking platform in precise alignment to each other contoured lamination and selectively bonding the laminations by acting through the carrier sheet with an adhesion-activating laser beam, a hot pointed tool, or DLP-projected patterns of light corresponding the shape of each lamination or laminations, wherein an adhesive is at a minimum activated in a continuous line or closely spaced spots within a narrow region adjacent to the internal boundary of each contoured lamination, wherein the narrow regions have a width being less than five percent (5%) of the width or length of an individual contour where the narrow regions are located; (g) peeling away the carrier sheet containing any unwanted fabrication material, and repeating the cutting, bonding and peeling steps until the construction of a desired three dimensional object is complete.

This preferential adhesive activation within the narrow region adjacent to the internal boundary of each contoured lamination of the three-dimensional object assures that the contour will be fully adhered to the stack. To obtain a more secure bond, the “selective bonding” step may be followed with a “general bonding” step applied over the entire surface of a contoured lamination. The combination bonding can be performed on a layer-by-layer fashion or for an entire stack of formed and stacked laminations, for example, by compressing and heating the lamination or by immersing the lamination into a solvent.

The third of these alternative embodiments of the method of the present invention is directed to “selective adhesive deactivation” of the waste contours surrounding each contoured lamination. This third alternative method is very similar to the first and second alternative methods; however, the “selective adhesive deactivation” method uses an adhesive deactivation process and apparatus to apply adhesive to at least the overlapping portions of the waste material containing contours surrounding a given lamination after the fabrication material has been cut into individual contours. The adhesive deactivation process is performed to insure complete peeling away of the waste contours by the carrier sheet from the stack of contoured laminations after the stacking and bonding steps. Although the adhesive deactivation process can be performed in the “cut-before-bond” method as illustrated in FIG. 5, the adhesive deactivation process can also be accomplished in the “bond before cut” technique illustrated in FIG. 17. When the printer of the system adds a deactivating ink, then the adhesive deactivation does not have to be complete. Deactivation of the adhesive need only be sufficient to weaken the bond between the layers of the waste material to the extent that the waste material may be easily removable by hand, especially when the waste material is crosshatched.

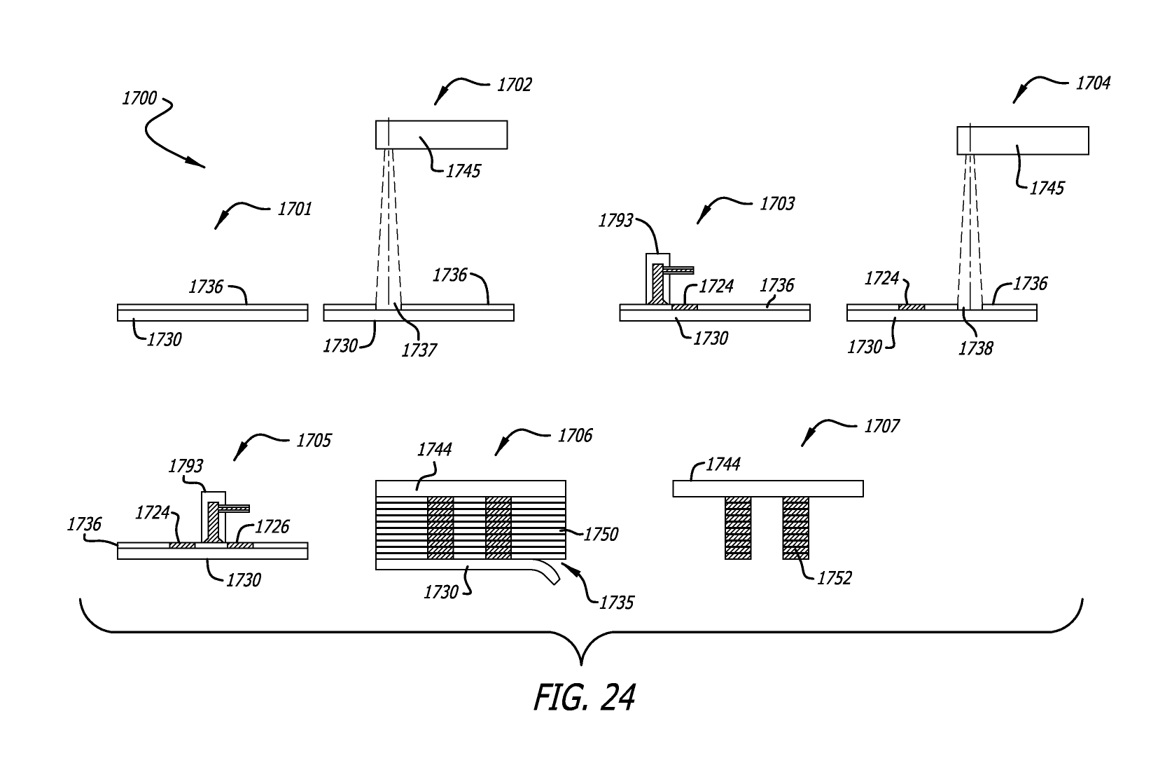

Referring now to FIG. 24, another embodiment of the 3D printing process 1700 of the present invention is directed to using sheet materials that can also be applied for tissue engineering. Tissues having several cell types can be manufactured in using the following steps: (a—1701) provide a thin sheet of sacrificial material 1736 suitable for tissue engineering (for example, a sugar) on a conveyor or a release carrier sheet 1730; (b—1702) ablate a portion of the sacrificial material using a scanned laser beam 1745 or a water etching technique similar to ablating techniques described herein; (c—1703) refill the areas in the sacrificial sheet 1737 vacated by ablation or etching with a first cell type 1724; (d—1704) ablate and etch a second area 1738 in the thin sheet of sacrificial material and refill 1705 the second ablated area with a second cell type 1726; (e) the ablate and refill steps 1702, 1703, 1704, 1705 can be continued for additional cell types; (f—1706) assemble the sheets of sacrificial having deposited cell material into a stack 1750 bonded to a lamination platform 1744 and remove 1735 the carrier sheet; (g—1707) dissolve the sacrificial material to release the tissue stack 1752 having multiple cell types. The same steps can be carried out while performing “bond-before-cut” process as described herein.

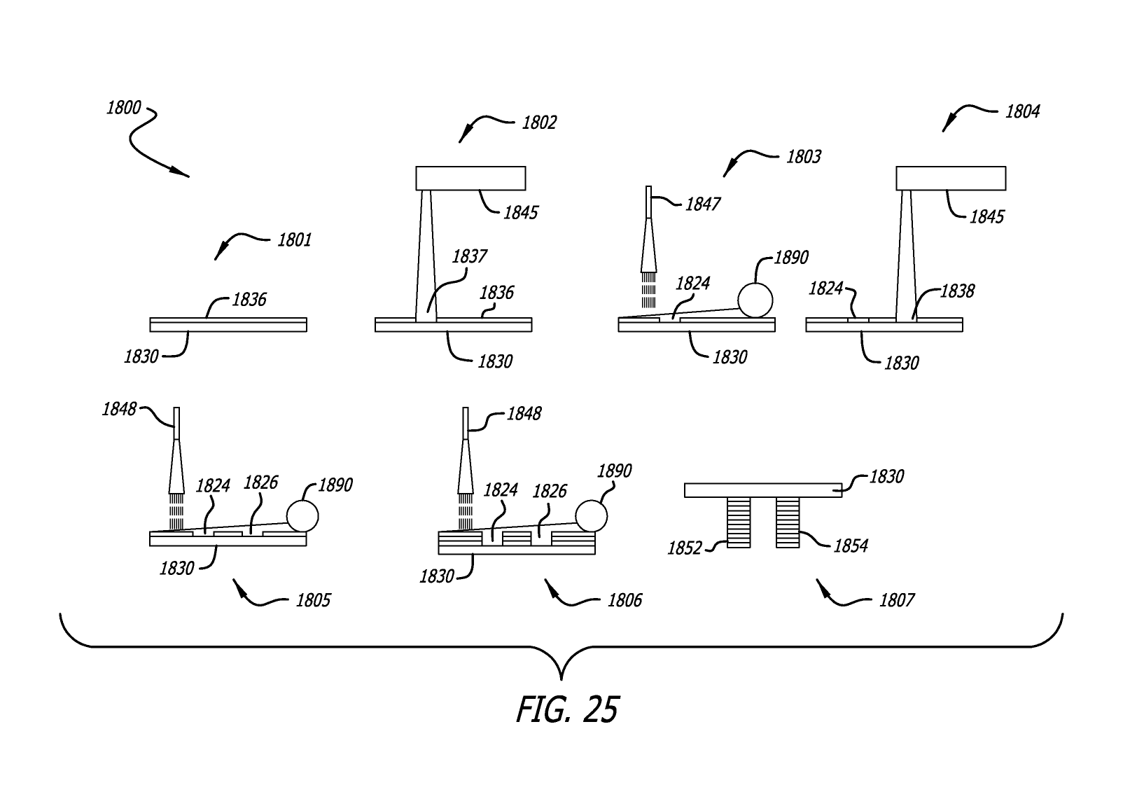

Referring now to FIG. 25, another embodiment of the 3D printing process 1800 of the present invention is directed to manufacturing 3D metal or ceramic objects using a plasma spray refill process. The plasma spray (or other types of metal or ceramic spray) method includes the following steps: (a—1801) attach a sheet or layer of sacrificial material 1836 to a carrier sheet 1830, for example, the sacrificial sheet could be made out of paper, a plastic, a dissolvable paper, alternatively, the sacrificial material may be deposited as a flowable substance, such as a layer of molten wax, gypsum or cement; (b—1802) ablate a portion (spaces) 1837 of the sacrificial material layer using a laser scanner 1845 or other suitable device; (c—1803) refill the vacated spaces in the sacrificial material layer with a first fabrication material 1824 using plasma or another type of spray mechanism 1847, wherein the sprayed first fabrication material refills the spaces vacated by the laser ablation, and wherein a grinding or other device 1890 is used to level the surface of the sprayed fabrication material; (d—1804) ablate a second portion 1838 of the sacrificial sheet using the laser scanner; (e—1805) refill the empty spaces in the second ablated portion of the sacrificial sheet with a second fabrication material 1826 using the same spraying technique and the same or similar spray mechanism 1848 and level the surface of the sprayed second fabrication material by grinding off the excess second fabrication material from the sacrificial layer, wherein the ablating, refilling and grinding steps 1802, 1803 can be repeated for additional fabrication materials; (f—1806) repeat the attaching a layer of sacrificial material, ablating, refilling and grinding steps 1801, 1802, 1803, 1804, 1805 and then attach each refilled sacrificial layer to the previous refilled sacrificial layer, wherein the process may be continued for as many layers as necessary to build the desired object; (g—1807) after all of the layers have been formed, dissolve, burn or break the sacrificial material and release the parts 1852, 1854 for forming a multi-material 3D object.

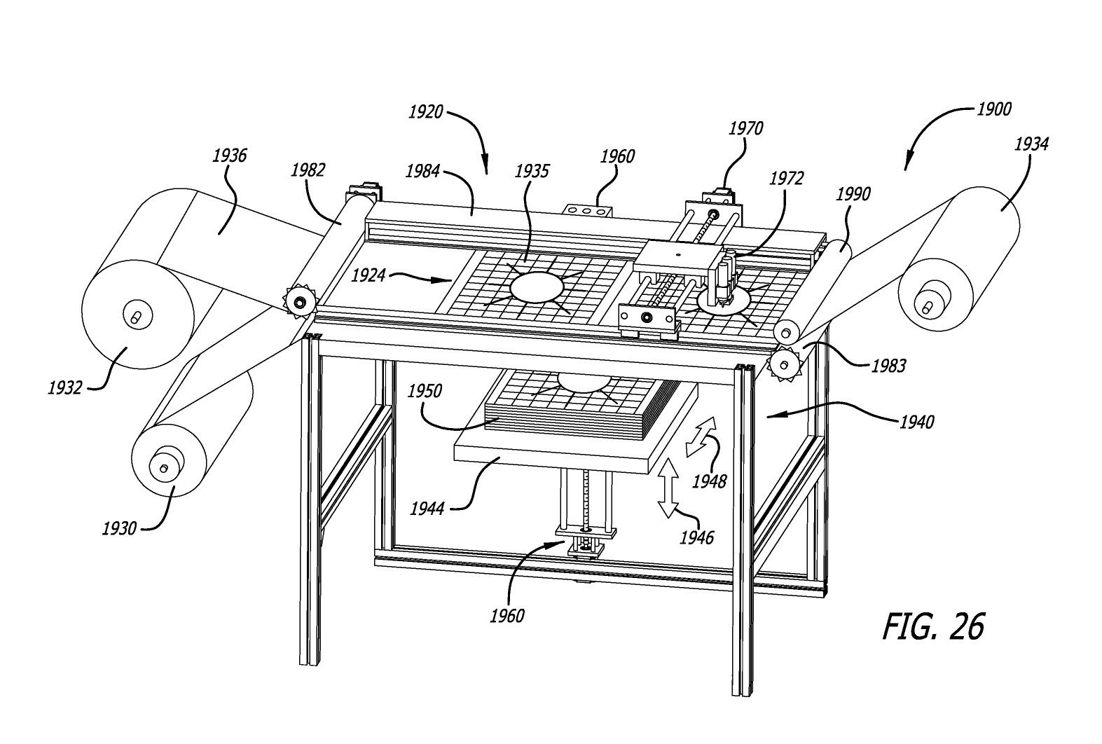

Referring now to FIG. 26, another embodiment of the three-dimensional printing process of the present invention is directed to a “bond-before-cut” technique without concurrent removal of waste material. Specifically, an embodiment of the laminated object manufacturing (LOM) apparatus 1900 of the present invention combines the layer forming and laminating modules into one unit (station) 1920 having an X-Y positioning module 1970 for moving the a knife or laser 1972. For simplicity, FIG. 26 shows a linear sequence of contoured laminations (layers) 1924 that are first cut and then bonded to the stack 1950 positioned by a stacking station 1940. Alternatively, several or all of the successive contoured laminations of the manufactured three-dimensional object can be formed as an array distributed both along and across the fabrication ribbon 1936 prior to bonding onto a lamination plate 1944 that is moved vertically 1946 by a positioning assembly 1960. Subsequently, contoured laminations can be collected on the stack.

The fabrication ribbon 1936 is stabilized on a removable carrier ribbon or a conveyor 1930. The fabrication ribbon is moved by a set of drive rollers 1984 from a feed roll 1932 towards a strip-off roller 1990 and waste rewind roll 1934 at the opposite end of the LOM apparatus 1900. By way of example, the raw material on the fabrication ribbon that is used to form the contoured laminations 1924 may be a thin sheet or a film made from a thermoplastic, a metal foil, a “green” ceramic film, or a composite material.

The contoured laminations (layers) 1924 can be formed by kiss-cutting the material on the fabrication ribbon 1936 into the contours of the desired three-dimensional object and forming a cross-hatch pattern 1935 surrounding the contour. These contoured laminations are similar to those produced in the versions of the LOM apparatus previously described herein. In another aspect of the present invention, multiple layer-forming stations 1920 may be configured to simultaneously cut the contours of the desired three-dimensional object, which is unique for this version of LOM process.

One of the greatest challenges of a LOM process is in aligning the contoured laminations 1924 produced on the carrier ribbon 1930 with the laminating platform 1944 as it brings the stack of layers 1950 into contact during the laminating process. As shown in FIG. 26, the material feeding mechanism can be equipped with a sprocket drive 1982, 1983 so that the contoured laminations produced at the forming station 1920 will remain in registration as the laminations move towards the laminating platform. The sprocket drives, however, may be insufficient to insure proper registration of the laminations, wherein active registration assisted with computer-controlled stages may be required to move the lamination platform horizontally 1948 and/or in a rotational manner.

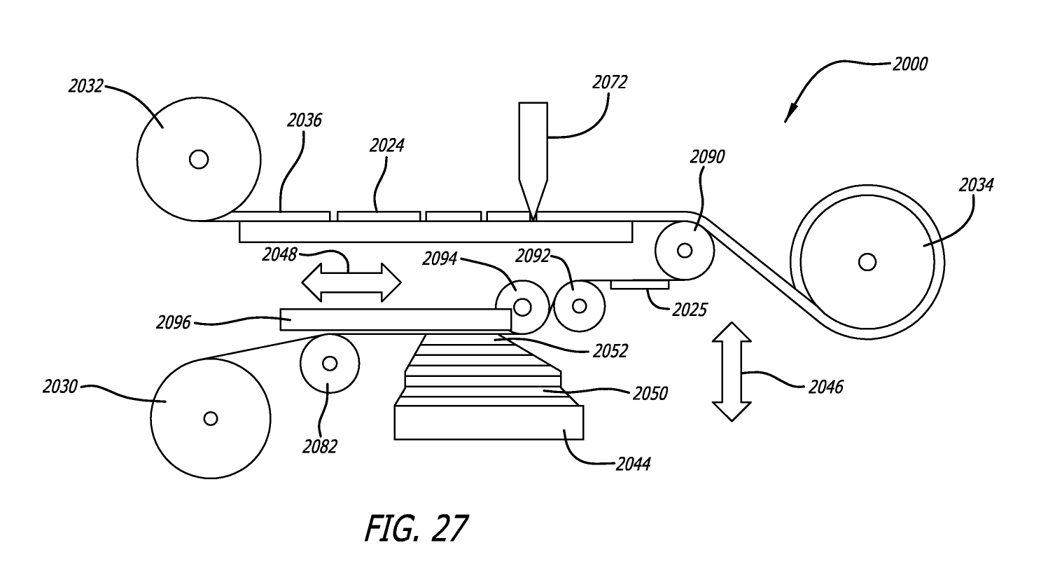

referring now to FIG. 27, a the material path is depicted for an alternative embodiment of the laminated object manufacturing machine 2000 of the present invention, wherein the layer forming and the laminating modules are combined into one in one apparatus. In order to attach a new contoured lamination 2024 in this machine, a lamination platform 2044 having a stack 2050 of accumulated laminations (layers) moves upwards 2046 until the upper layer 2052 contacts a new contoured lamination (layer) 2025 located under the carrier ribbon 2030. The lamination platform compresses the new contoured lamination against a heated laminating plate 2096. Alternatively, the new contoured lamination (layer) may be heated and bonded to the stack by a heating mechanism attached to the bottom of the laminating platform of the machine.

After the new contoured lamination (layer) 2025 becomes attached to the stack 2050 through the heat-induced bond, the laminating platform 2044 moves a short distance down 2046. Next the laminating plate and the peel off rollers 2092, 2094 attached to the lamination plate 2048 move above the newly attached layer, while pealing the carrier ribbon 2030 away from the stack 2050. During this movement 2048, a leveling roller 2094 of the peel off roller assembly 2090 presses against the laminated stack completing and enhancing the adhesion of the newly added layer. The leveling roller may be equipped with needles or spikes to remove any air bubbles from the newly attached layer. Next the peel off roller assembly moves back to its home position so that the heated laminating plate 2096 is above the lamination platform and stack of bonded contoured laminations. The fabrication material 2036 then advances from the unwind roll 2032. Alternatively, the fabrication material does not advance, but the laminating platform, which is configured for movement across the carrier ribbon 2030 makes such a move and is positioned against a new contoured lamination located in the next row, and the process repeats. The LOM machine adds new contoured laminations to the stack until all layers have been added to form the desired three-dimensional object.

Color is an important and desirable feature of three-dimensional objects. Although the prior art described methods for creating a color pattern on edges of a layer by printing the pattern on color transmitting or color paint absorbing media. An improvement may be to deliver color onto the edges of cut or formed contoured laminations (layers) after they have been created. In such alternative process the paint should flow over the edges of the contoured lamination during the printing step. Accordingly, each of the three-dimensional object forming methods of the present invention described herein can include a step of printing color profiles corresponding to the color of the edges of each layer of the object over the edge-inclusive regions of these layers after they have been formed, thus, enabling a colored three-dimensional object creation, even if the fabrication sheet is non-transparent or ink-absorbing.

While certain aspects of the invention have been illustrated and described herein in terms of its use specific materials, it will be apparent to those skilled in the art that the laminated layers can be made from many materials not specifically discussed herein. Further, any sizes and dimensions of the apparatus have been described herein and are provided as examples only. Other modifications and improvements may be made without departing from the scope of the invention. Accordingly, it is not intended that the invention be limited beyond the intended scope of the invention, for example, but not limited to, the appended claims.

I claim:

1. A method of forming an integral three-dimensional object from sheet laminations, comprising:
providing a length of film;
providing forming means for defining the shape of consecutive layers of the three dimensional object by dividing the film into regions that constitute the layers of the object and the surrounding regions intended for removal;
providing connecting means for maintaining physical connection between separate regions constituting the formed layers prior to their attachment to each other, so that the unconnected portions of the layers remain in registration to one another after the material surrounding them has been removed;
providing removing means for removing waste portions the film that do not belong to the layers of the three-dimensional object;
providing stacking means for stacking the formed layers to each other;
providing alignment means for alignment the layers in precise registration to each other while they are being stacked;
providing bonding means for bonding the stacked layers to each other;
applying forming means to the consecutive layers of the three-dimensional object distributed both along the film material and across it, while maintaining the connection between separate regions of the formed layers by the connecting means;
applying removing means for removing portions of the film surrounding the formed layers of the object;
adding one or several formed layers to the stack by applying the stacking means, the alignment means and the bonding means; and
chemically dissolving or mechanically removing the connecting means after one or several layers have been attached to the stack.

2. The method of claim 1, where the forming means are comprised of a source of a curing light that separates the film into removable and non-removable portions by altering their mechanical or chemical properties.

3. The method of claim 2, wherein the removing means are comprised of water or a solvent selectively removing regions surrounding the formed layers of the object.

4. The method of claim 2, wherein prior to the forming the film is coated with a photoresist.

5. The method of claim 1, wherein the connecting means are comprised of one or more materials added to the film in order to refill the spaces vacated by the removal means.

6. The method of claim 5, wherein the refilling of the spaces is accomplished by spraying or electrodepositing a metal.

7. The method of claim 5, wherein refilling the spaces is done with a molten or curable material, such as a metal, or a polymer or a powder based substance capable of transition from a flowing state into a solid state.

8. The method of claim 5, wherein the formed and stacked layers of the film are dissolved or mechanically removed releasing a three-dimensional object composed of the refilling material.

9. The method of claim 5, wherein the refilling is followed by leveling the refill material with the surface of the film.

10. The method of claim 1, wherein the alignment means includes a rectangular or a repeatable geometry created as a feature of each of the formed layers.

11. The method of claim 1, wherein the connecting means are comprised of a vacuum, magnetic or electrostatic conveyor.

12. The method of claim 1, wherein the connecting means are comprised of a carrier film removably connected to the film.

13. The method of claim 1, wherein the connecting means are comprised of geometric features of the formed film connecting separate regions of a given layer.

14. The method of claim 1, wherein the bonding step performed for one or several formed layers.

15. The method of claim 1, wherein the three-dimensional object is used as a sacrificial mold, which is first filled with another substance and then dissolved.

16. The method of claim 15, wherein the mold has several enclosed spaces, each space being used for injecting the same or a different material used for making an assembly potentially composed of multiple materials, the assembly obtained once the water or solvent-soluble mold has been dissolved.

17. The method of claim 1, further including a step of printing color profiles corresponding to the color of the edges of each layer of the object.

18. The method of claim 1, wherein the carrier includes a layer of a metal foil.

19. The method of claim 1, wherein the removing or the forming means are comprised of a laser beam selectively cutting or ablating the film.

20. The method of claim 12, wherein the film is coated with a light-curable adhesive and wherein the bonding of each formed layer to other layers is accomplished by bringing it into the contact with the stack of the previously bonded layers in precise alignment to them and selectively bonding the portions of the layer, which belong to the object by acting through the carrier with an adhesion-activating pattern of curing light, peeling away the carrier material with any unwanted material remaining on it, and repeating the cutting, and bonding steps until the lamination of the three dimensional object is complete.

21. The method of claim 12, wherein the bonding of each formed layer to other layers is accomplished by bringing it into the contact with the stack of the previously bonded layers in precise alignment to them and selectively bonding the portions of the layer, which belong to the object by acting through the carrier with pointed source of heat, peeling away the carrier material with any unwanted material remaining on it, and repeating the cutting, and bonding steps until the lamination of the three dimensional object is complete.

22. A method of claim 12, wherein the removing waste portions the film that do not belong to the layers of the 3D object is aided by a weeding tape, which is maintained in a frictional contact with the top surface of the fabrication material, so that advancing the supply film cases the same advance of the weeding tape; depositing adhesive within formed contours containing waste; that adhesive being at a minimum deposited in a continuous line or closely spaced spots within a narrow region adjacent to the internal boundary of each contour of that waste; these narrow regions having their width being less than five percent of the width or length of an individual contour where they are located; advancing the sheet material from the unwind roll to its rewind while simultaneously activating adhesion between the weeding tape and the waist contours; pulling the weeding tape away from the film, thus, causing peeling waist's contours off onto the weeder tape.

23. The method of claim 1, wherein the film is first bonded to the stack and then formed into a layer, and wherein a laterally movable stacking platform enables forming the layers of a 3D object distributed both along and across the supply ribbon.

24. A method of claim 1, wherein the contours of the formed layers are surrounded by a region of the waste material diced into rectangular crosshatched pattern.

25. An apparatus for forming an integral three-dimensional object from sheet laminations, comprising:
means for moving a length of film stabilized on a conveyor or a removable carrier;
means for forming an array of layers of the three-dimensional object out of the film distributed both along the film and across the film;
means for removing individual layers from the carrier or the conveyor,
means for stacking and bonding the layers in precise registration to one another; and
means for insuring that the stacked laminations are in precise alignment with one another.

26. The apparatus of claim 25, wherein the stacking means is comprised of a platform movable on a combination of slides towards and away from the formed layers, and across the length of the film.

27. The apparatus of claim 26, wherein the laminating means include a laminating plate located opposite to the reciprocally movable platform with the carrier based film positioned in between that plate and that platform with the carrier side facing the laminating plate.

28. The apparatus of claim 27, wherein the laminating plate is heated.

29. The apparatus of claim 27, wherein the laminating plate is movable parallel to the laminations accumulated on the laminating platform.

30. The apparatus of claim 29, wherein the movable laminating plate is connected to a peel off roller assembly capable of pulling away the carrier from the laminated stack as the plate moves parallel to the laminations.

31. The apparatus of claim 26, wherein, in order to achieve alignment of the consecutive layers the motion of the platform is guided by an input from an optical sensor registration marks or the repeatable layer geometry provided by the layer forming means.

32. An apparatus for forming an integral object from sheet laminations, comprising:
a layer-forming station that forms individual layers of a three-dimensional in an array distributed along and across a film removably attached to a carrier ribbon or carried by a conveyor; and
a stacking station where the individual layers are assembled in precise registration to one another.
